(19) United States
(12) Patent Application Publication
(10) Pub. No.: US 2025/0242253 A1
(43) Pub. Date: Jul. 31, 2025

(54) STORAGE MEDIUM, INFORMATION PROCESSING SYSTEM, INFORMATION PROCESSING APPARATUS, AND INFORMATION PROCESSING METHOD

(71) Applicant: NINTENDO CO., LTD., Kyoto (JP)

(72) Inventors: Atsushi UENO, Kyoto (JP); Akane YOSHIDA, Kyoto (JP)

(21) Appl. No.: 19/040,170

(22) Filed: Jan. 29, 2025

(30) Foreign Application Priority Data
Jan. 30, 2024 (JP) 2024-011602

(51) Int. Cl. A63F 13/57

(52) U.S. Cl. CPC A63F 13/57

(57) ABSTRACT

An example of an information processing system places a player object and a non-player object in a virtual space. The information processing system moves the player object in the virtual space, based on a user input. The non-player object is deformed from a first shape to a second shape that imitates a letter or a mark, according to a condition including that the player object is located within a range in the vicinity of the non-player object, and/or that the player object faces the non-player object.

### CROSS REFERENCE TO RELATED APPLICATION

This application claims priority to Japanese Patent Application No. 2024-011602, filed on Jan. 30, 2024, the entire contents of which are incorporated herein by reference.

### FIELD

The present disclosure relates to a storage medium, an information processing system, an information processing apparatus, and an information processing method for controlling a non-player object that appears in a game space.

### BACKGROUND AND SUMMARY

Conventionally, when a player object approaches a non-player object in a game space, a speech balloon representing “. . . ” or “!” is displayed above the head of the non-player object with which the player object can have a conversation.

The speech balloon displayed above the head of the non-player object may be insufficient for drawing user's attention to the non-player object, and therefore, a method for drawing more attention of the user has been desired.

Therefore, the present application discloses a storage medium, an information processing system, an information processing apparatus, and an information processing method capable of drawing more attention of the user to a non-player object.

(1)

An example of one or more non-transitory computer-readable storage medium having stored therein instructions that, when executed, cause one or more processors of an information processing apparatus to execute information processing comprising: placing a player object and a non-player object in a virtual space; moving the player object in the virtual space, based on a user input; and deforming the non-player object from a first shape to a second shape that imitates a letter or a mark, according to a first condition including that the player object is located within a first range in the vicinity of the non-player object, and/or that the player object faces the non-player object.

According to the configuration of the above (1), since the shape of the non-player object itself is deformed, the non-player object can attract more attention of the user.

(2)

In the configuration of the above (1), the second shape may be a letter or a mark representing a direction.

According to the configuration of the above (2), the direction in which the player object should proceed can be informed to the user in an intuitive and easy-to-understand manner.

(3)

In the configuration of the above (1) or (2), the non-player object may be deformed from the first shape to the second shape that is an arrow, and the direction represented by the second shape may be changed by rotating the non-player object.

According to the configuration of the above (3), since the second shape need not be stored for each direction of the arrow, labor for generating data of the second shape can be reduced.

(4)

In the configuration of the any one of above (1) to (3), the second shape may imitate “!” or “?”.

(5)

In the configuration of the any one of above (1) to (4), the information processing may further comprise: causing a display device to display a message from the non-player object, according to a display condition having been satisfied.

According to the configuration of the above (5), information that the second shape cannot sufficiently inform to the user can be informed to the user through the message.

(6)

In the configuration of the above (5), the message may indicate a content regarding the second shape.

According to the configuration of the above (6), details of the information indicated by the second shape can be informed to the user through the message.

(7)

In the configuration of the above (6), the second shape may imitate an arrow. The message may be a sentence that gives a direction to the player object.

According to the configuration of the above (7), the direction in which the player object should proceed can be informed to the user through the second shape, and detailed guidance can be informed to the user through the message.

(8)

In the configuration of the above (6), the second shape imitates “?”. The message may be a question to the player object.

According to the configuration of the above (8), the presence of the question can be informed to the user through the second shape, and the content of the question can be informed to the user through the message.

(9)

In the configuration of the any one of above (1) to (8), the non-player object may be gradually deformed from the first shape to the second shape.

According to the configuration of the above (9), the non-player object can more easily attract the attention of the user.

(10)

In the configuration of the above (9), the shape of the non-player object may be determined based on voxel data of each voxel that is set in a voxel space. The non-player object may be gradually deformed from the first shape to the second shape through an interpolation process using the voxel data representing the first shape and the voxel data representing the second shape.

According to the configuration of the above (10), the interpolation process is facilitated by using the voxel data.

(11)

In the configuration of the above (9) or (10), the information processing may further comprise: in a case where at least a part of the non-player object is deleted when the non-player object has the first shape, gradually restoring the shape of the non-player object to the first shape according to a lapse of time; and in a case where at least a part of the non-player object is deleted when the non-player object has the second shape, gradually restoring the shape of the non-player object to the second shape according to a lapse of time.

According to the configuration of the above (11), regardless of whether the non-player object has the first shape or the second shape, the non-player object can be restored to the shape immediately before the deletion.

(12)

In the configuration of the above (11), in a case where the first condition is satisfied when the non-player object is in the middle of restoration to the first shape, the non-player object may be restored to the first shape and thereafter is deformed to the second shape.

According to the configuration of the above (12), the non-player object can more reliably attract the attention of the user.

(13)

In the configuration of the any one of above (1) to (12), in a case where the first condition is satisfied when the shape of the non-player object is different from the first shape due to a reason different from deformation from the first shape to the second shape, the non-player object may be deformed to the first shape and thereafter is deformed to the second shape.

According to the configuration of the above (13), the non-player object can more reliably attract the attention of the user.

(14)

In the configuration of the any one of above (1) to (13), the non-player object may have a first part that deforms from the first shape to the second shape, and a second part different from the first part. The position of the second part may be changed according to deformation of the first part from the first shape to the second shape.

According to the configuration of the above (14), the appearance of the non-player object can be made more natural.

(15)

In the configuration of the above (14), the position of the second part may be gradually changed according to gradual deformation of the first part from the first shape to the second shape.

According to the configuration of the above (15), the appearance of the non-player object can be made more natural even while the non-player object is being deformed.

(16)

In the configuration of the above (14) or (15), the non-player object may be a non-player character. The second part may be eyes of the non-player character.

According to the configuration of the above (16), the position of the eyes of the non-player object can be made natural.

(17)

In the configuration of the any one of above (1) to (16), the information processing may further comprise: causing the non-player object to perform the same motion, when the non-player object has the first shape and when the non-player object has the second shape.

According to the configuration of the above (17), regardless of whether the non-player object has the first shape or the second shape, the non-player object can be moved in the same manner.

(18)

In the configuration of the any one of above (1) to (17), the information processing may further comprise: deforming the non-player object from the second shape to the first shape according to a second condition that is not satisfied when the first condition is satisfied, the second condition including that the player object is located outside a second range that is a range in the vicinity of the non-player object and is the same as or different from the first range, and/or that the player object does not face the non-player object.

According to the configuration of the above (18), since the non-player object can be restored to the first shape, the non-player object is again deformed to the second shape when the first condition is again satisfied, and therefore, the non-player object can again attract the attention of the user.

(19)

In the configuration of the any one of above (1) to (18), when the player object is located within a reference distance from the non-player object, the non-player object may be deformed from the first shape to the second shape.

According to the configuration of the above (19), the non-player object located near the player object can be deformed.

(20)

In the configuration of the any one of above (1) to (19), at least one of the color, pattern, and property of the non-player object may be further changed according to change of the shape of the non-player object from the first shape to the second shape due to the first condition.

According to the configuration of the above (20), the appearance and/or the property of the non-player character can be changed according to deformation of the non-player object.

Note that the present specification discloses examples of an information processing apparatus and an information processing system that execute the processes in the above (1) to (20). Further, the present specification discloses an example of an information processing method that executes the processes in the above (1) to (20).

According to the storage medium, the information processing system, the information processing apparatus, or the information processing method described above, the non-player object can attract more attention of the user.

These and other features, aspects and advantages of the subject matter described herein will become more apparent from the following detailed description when taken in conjunction with the accompanying drawings.

### BRIEF DESCRIPTION OF THE DRAWINGS

FIG. 1 is a view showing an example where a non-limiting left controller and a non-limiting right controller are attached to a non-limiting main body apparatus;

FIG. 2 is a view showing an example where a non-limiting left controller and a non-limiting right controller are removed from a non-limiting main body apparatus;

FIG. 3 is a six-sided view showing an example of a non-limiting main body apparatus;

FIG. 4 is a six-sided view showing an example of a non-limiting left controller;

FIG. 5 is a six-sided view showing an example of a non-limiting right controller;

FIG. 6 is a block diagram showing an example of an internal configuration of a non-limiting main body apparatus;

FIG. 7 is a block diagram showing an example of an internal configuration of a non-limiting main body apparatus, a non-limiting left controller and a non-limiting right controller;

FIG. 8 is a view showing an example of a terrain object, which is a voxel object;

FIG. 9 is a view showing before and after the deletion of a portion of the terrain object shown in FIG. 8;

FIG. 10 is a view showing before and after the deletion of a portion of the terrain object shown in FIG. 8;

FIG. 11 is a diagram showing an example of content of voxel data and content of material information;

FIG. 12 is a diagram showing an example of property information representing properties of materials;

FIG. 13 is a diagram showing an example of texture information representing textures of materials;

FIG. 14 is a diagram showing a method for generating a mesh;

FIG. 15 is a view showing an example of a game image including a terrain object;

FIG. 16 is a diagram showing an example of a state where a non-player character deforms;

FIG. 17 is a diagram showing an example of a state where a body object of the non-player character deforms;

FIG. 18 is a diagram showing an example of a state where an eye object and a foot object change when the non-player character deforms;

FIG. 19 is a diagram showing an example of deformation in which a suggestion shape is an upward arrow;

FIG. 20 is a diagram showing examples of marks that the suggestion shape represents, and the meanings of the respective marks;

FIG. 21 is a diagram showing an example of change in the non-player character when a deformation condition is satisfied while the non-player character, a part of which is deleted, is being restored;

FIG. 22 is a diagram showing an example of various data used for information processing in the non-limiting game system;

FIG. 23 is a flowchart showing an example of a flow of game processing executed by the non-limiting game system;

FIG. 24 is a sub-flowchart showing an example of a specific flow of a character deformation process in step S11 shown in FIG. 23; and

FIG. 25 is a sub-flowchart showing an example of a specific flow of the character deformation process in step S11 shown in FIG. 23.

### DETAILED DESCRIPTION OF NON-LIMITING EXAMPLE EMBODIMENTS

### 1. Configuration of Game System

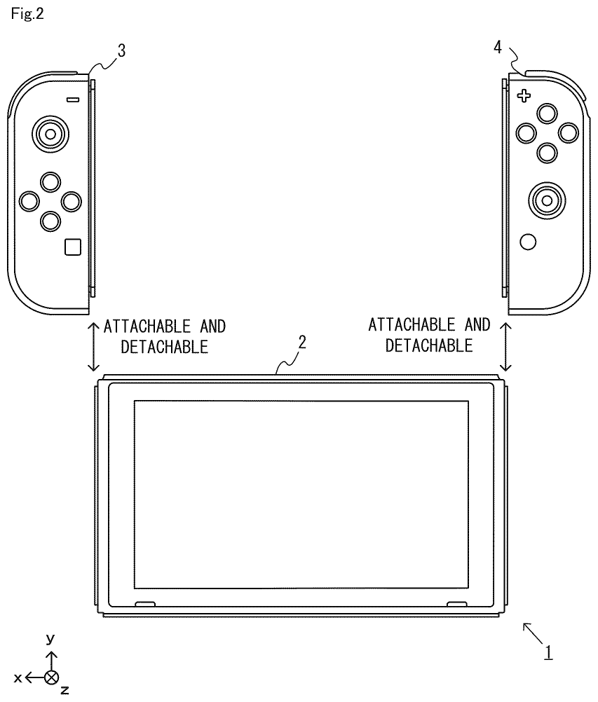

A game system according to an example of an exemplary embodiment is described below. An example of a game system 1 according to the exemplary embodiment includes a main body apparatus (an information processing apparatus; which functions as a game apparatus main body in the exemplary embodiment) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies (see FIG. 2). Hereinafter, first, the hardware configuration of the game system 1 according to the exemplary embodiment is described, and then, the control of the game system 1 according to the exemplary embodiment is described.

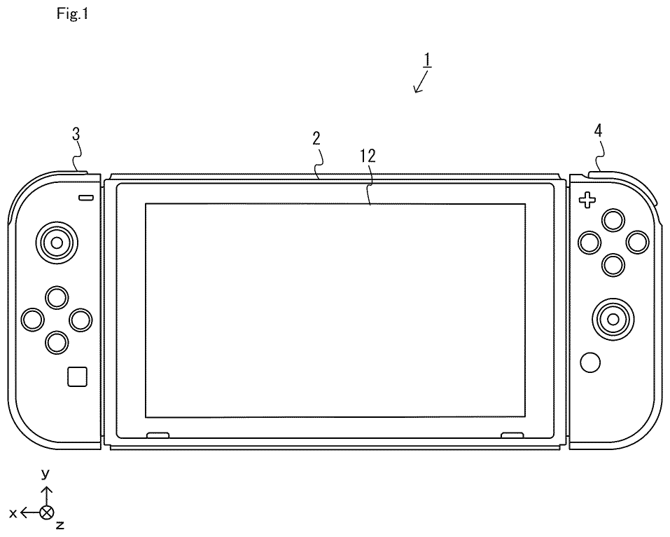

FIG. 1 is a diagram showing an example of the state where the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 2 is a diagram showing an example of the state where each of the left controller 3 and the right controller 4 is detached from the main body apparatus 2. As shown in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

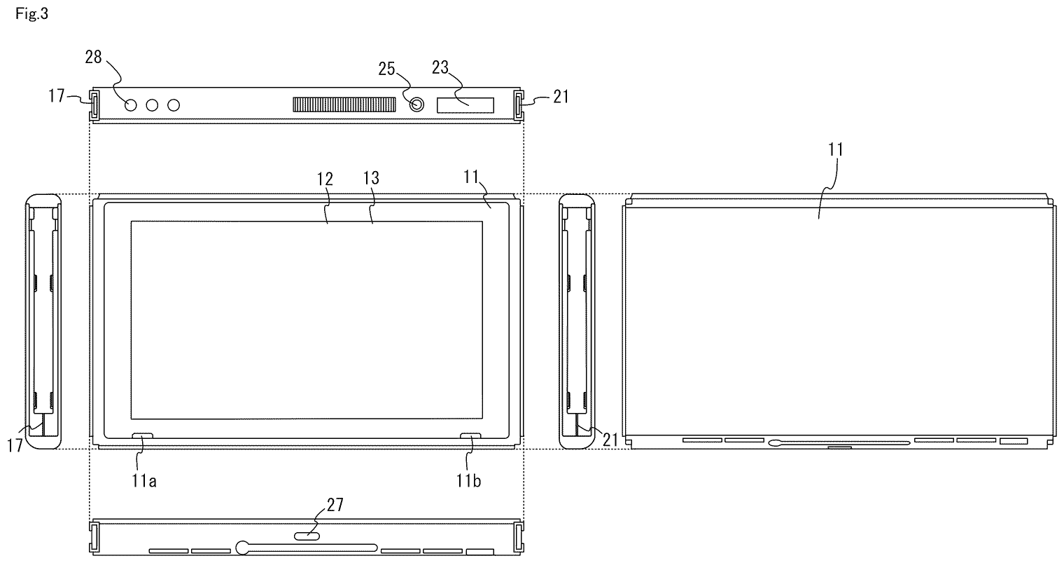

FIG. 3 is six orthogonal views showing an example of the main body apparatus 2. As shown in FIG. 3, the main body apparatus 2 includes an approximately plate-shaped housing 11. In the exemplary embodiment, a main surface (for example, a surface on a front side, such as a surface on which the display 12 is provided) of the housing 11 has a generally rectangular shape.

It should be noted that the shape and the size of the housing 11 are optional. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As shown in FIG. 3, the main body apparatus 2 includes the display 12, which is provided on the main surface of the housing 11. The display 12 displays an image generated by the main body apparatus 2. In the exemplary embodiment, the display 12 is a liquid crystal display device (LCD). The display 12, however, may be a display device of any type.

Further, the main body apparatus 2 includes a touch panel 13 on a screen of the display 12. In the exemplary embodiment, the touch panel 13 is of a type that allows a multi-touch input (e.g., a capacitive type). The touch panel 13, however, may be of any type. For example, the touch panel 13 may be of a type that allows a single-touch input (e.g., a resistive type).

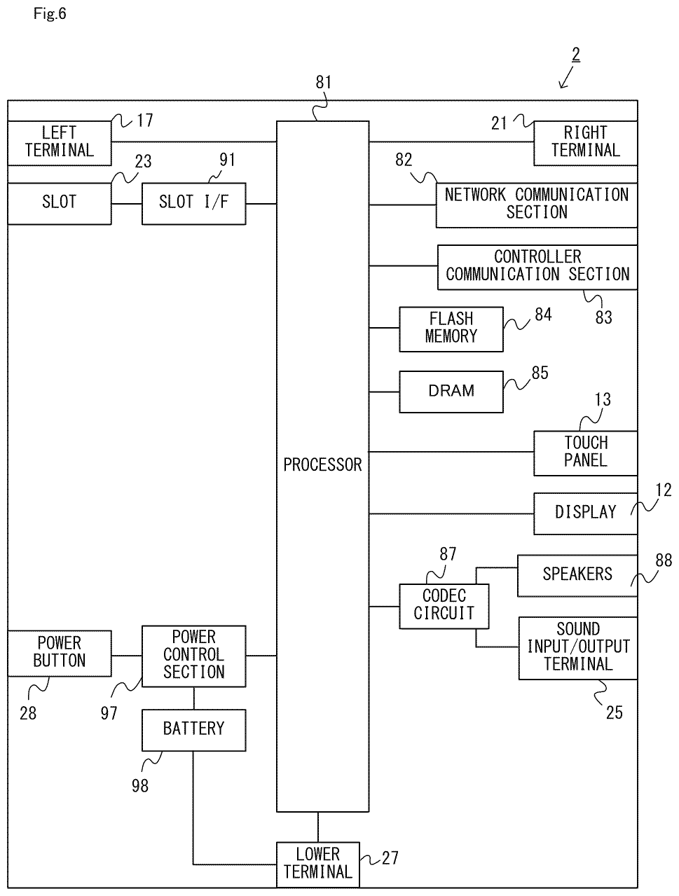

The main body apparatus 2 includes speakers (e.g., speakers 88 shown in FIG. 6) within the housing 11. As shown in FIG. 3, speaker holes 11a and 11b are formed on the main surface of the housing 11. Then, sounds output from the speakers 88 are output through the speaker holes 11a and 11b.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

As shown in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower terminal 27. The lower terminal 27 is a terminal for the main body apparatus 2 to communicate with a cradle. In the exemplary embodiment, the lower terminal 27 is a USB connector (more specifically, a female connector). Further, when the unified apparatus or the main body apparatus 2 alone is mounted on the cradle, the game system 1 can display on a monitor an image generated by and output from the main body apparatus 2. The monitor may be stationary or may be movable. Further, in the exemplary embodiment, the cradle has the function of charging the unified apparatus or the main body apparatus 2 alone mounted on the cradle. Further, the cradle has the function of a hub device (specifically, a USB hub).

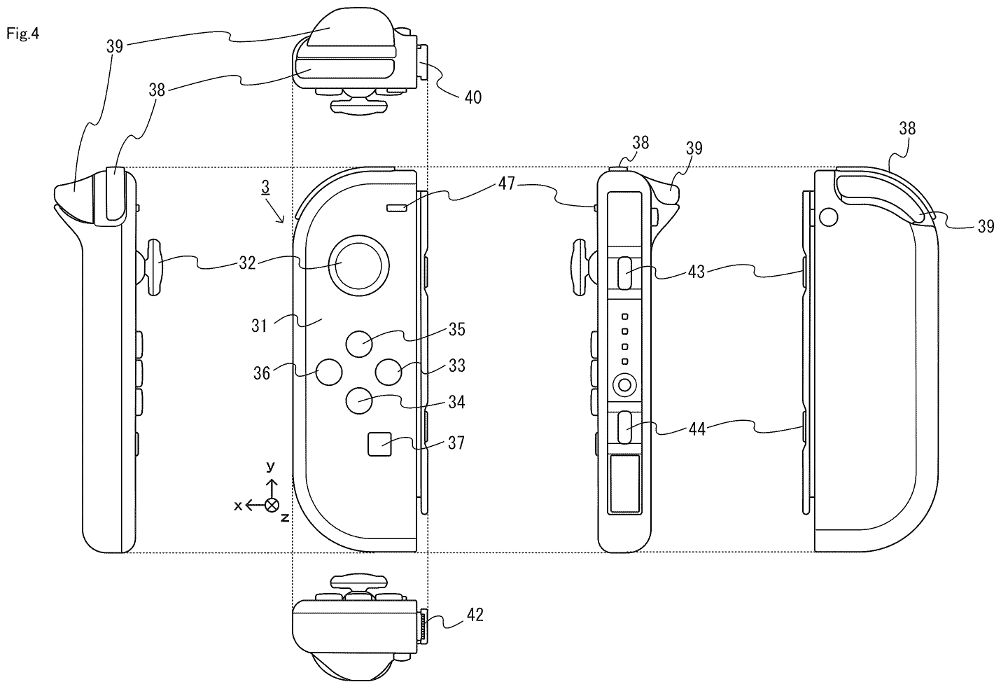

FIG. 4 is six orthogonal views showing an example of the left controller 3. As shown in FIG. 4, the left controller 3 includes a housing 31. In the exemplary embodiment, the housing 31 has a vertically long shape. The housing 31 may be shaped to be long in an up-down direction. For example, along the y-axis direction shown in FIGS. 1 and 4. In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As shown in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the exemplary embodiment, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an operating system (OS) program and an application program) executed by the main body apparatus 2.

Further, the left controller 3 includes a terminal 42 for the left controller 3 to perform wired communication with the main body apparatus 2.

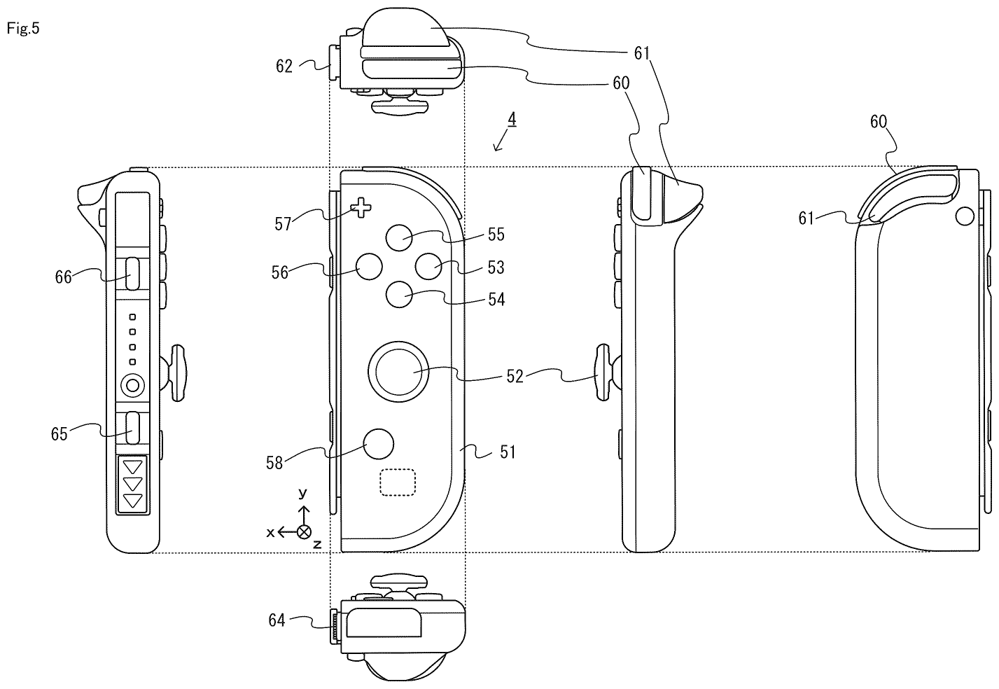

FIG. 5 is six orthogonal views showing an example of the right controller 4. As shown in FIG. 5, the right controller 4 includes a housing 51. In the exemplary embodiment, the housing 51 has a vertically long shape. For example, it may be shaped to be long in the up-down direction. In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the exemplary embodiment, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for the right controller 4 to perform wired communication with the main body apparatus 2.

FIG. 6 is a block diagram showing an example of the internal configuration of the main body apparatus 2. The main body apparatus 2 includes components 81 to 85, 87, 88, 91, 97, and 98 shown in FIG. 6 in addition to the components shown in FIG. 3. Some of the components 81 to 85, 87, 88, 91, 97, and 98 may be mounted as electronic components on an electronic circuit board and accommodated in the housing 11.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) or other instructions that are stored in storage. For example, in an internal non-transitory storage medium such as a flash memory 84, an external non-transitory storage medium attached to the slot 23, or the like), thereby performing the various types of information processing.

The main body apparatus 2 includes a flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing. The DRAM 85 and flash memory 84 are illustrative non-limiting examples of non-transitory computer-readable media.

The main body apparatus 2 includes a slot interface (hereinafter abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 directly communicate with each other to transmit and receive data.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2 and the left controller 3 and the right controller 4 is optional. In the exemplary embodiment, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the stationary monitor or the like via the cradle.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of users can simultaneously provide inputs to the main body apparatus 2, each using a set of the left controller 3 and the right controller 4. As an example, a first user can provide an input to the main body apparatus 2 using a first set of the left controller 3 and the right controller 4, and simultaneously, a second user can provide an input to the main body apparatus 2 using a second set of the left controller 3 and the right controller 4.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). Based on a command from the processor 81, the power control section 97 controls the supply of power from the battery 98 to the above components.

Further, the battery 98 is connected to the lower terminal 27. When an external charging device (e.g., the cradle) is connected to the lower terminal 27, and power is supplied to the main body apparatus 2 via the lower terminal 27, the battery 98 is charged with the supplied power.

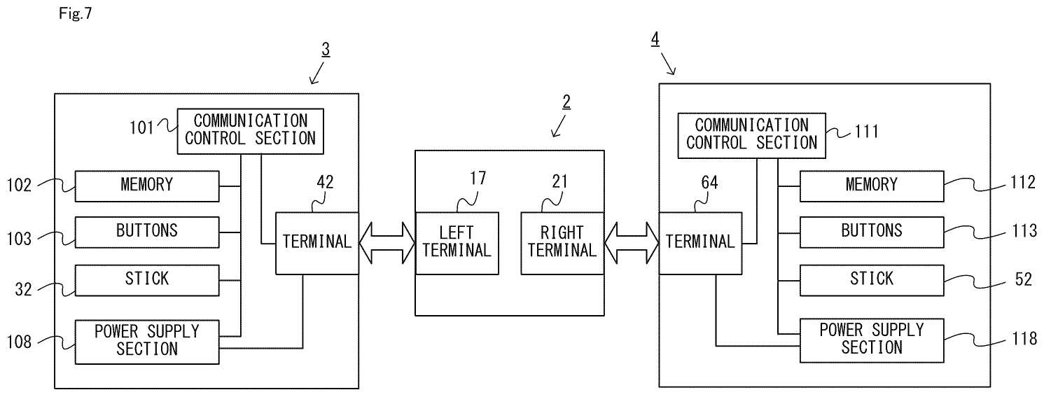

FIG. 7 is a block diagram showing examples of the internal configurations of the main body apparatus 2, the left controller 3, and the right controller 4. It should be noted that the details of the internal configuration of the main body apparatus 2 are shown in FIG. 6 and therefore are omitted in FIG. 7.

The left controller 3 includes a communication control section 101, which communicates with the main body apparatus 2. As shown in FIG. 7, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing.

The communication control section 101 acquires information regarding an input (specifically, information regarding an operation or the detection result of the sensor) from each of input sections (specifically, the buttons 103 and the analog stick 32). The communication control section 101 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the exemplary embodiment, the power supply section 108 includes a battery and a power control circuit. Although not shown in FIG. 7, the power control circuit is connected to the battery and also connected to components of the left controller 3 (specifically, components that receive power supplied from the battery).

As shown in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113 and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

### 2. Outline of Process on Game System

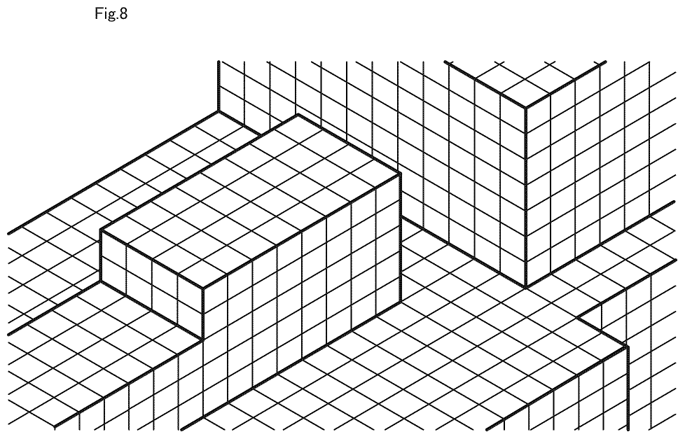

Next, referring to FIG. 8 to FIG. 21, an outline of the process performed on the game system 1 will be described. In the exemplary embodiment, the game system 1 generates a game image in which terrain objects and characters (e.g., the player character controlled by the player) are arranged in a game space, which is a three-dimensional virtual space, and displays the game image on a display device. Note that in the exemplary embodiment, the display device on which the game image is displayed may be the display 12 described above, or may be a stationary monitor.

### 2-1. Voxel

In the exemplary embodiment, for some objects in the game space, the shape is defined by voxel data. Here, voxels are rectangular parallelepiped (more specifically, cubic) regions arranged in a grid pattern in the game space, and voxel data is data that is set for each voxel. Hereinafter, an object whose shape is defined by voxel data will be referred to as a “voxel object”. In the exemplary embodiment, the game system 1 stores voxel data for each of a plurality of voxels that are set in the game space as data for generating voxel objects in the game space.

FIG. 8 is a view showing an example of a terrain object, which is a voxel object. As shown in FIG. 8, in the exemplary embodiment, a terrain object representing a terrain such as a ground surface has its shape defined by voxel data. The cubes shown in FIG. 8 represent a terrain object. Note that in FIG. 8, edges of the terrain object are indicated by thick lines. However, these thick lines are added for the purpose of making the drawings easier to understand, and there is no need for edges of the terrain object to be drawn thick.

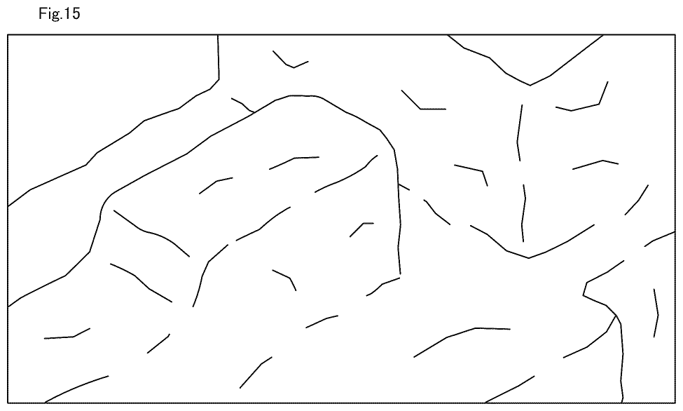

For example, the terrain object shown in FIG. 8 is generated by the following rule: “a cube is placed at the position of a voxel if a parameter included in the voxel data set for the voxel is greater than a predetermined value, and nothing is placed at the position of the voxel if the parameter is less than or equal to the predetermined value”. A terrain object in FIG. 8 is shown for the purpose of illustrating the relationship between voxels and voxel objects in an easy-to-understand manner. Note that in the exemplary embodiment, in practice, a voxel object is generated (e.g., based on voxel data) by such a rule that results in a terrain object having a complicated shape in comparison with the cubic voxels, such as a terrain object shown in FIG. 15 to be described below, for example. Note that there is no limitation on the rule for determining the shape of the voxel object based on the voxel data. In other embodiments, the game system 1 may generate a voxel object as shown in FIG. 8 based on the object data or may generate a voxel object as shown in FIG. 15 based on the object data.

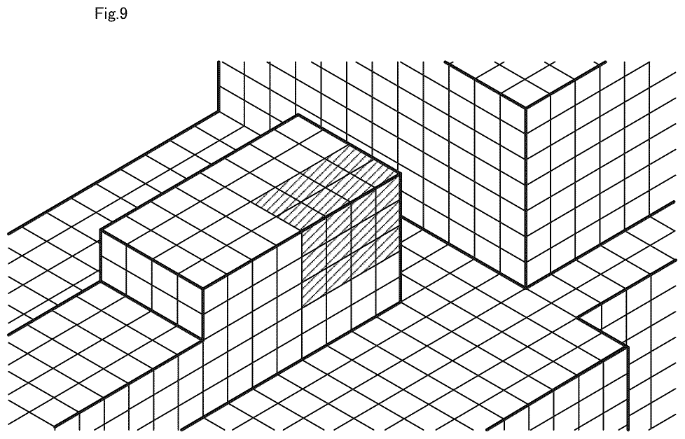

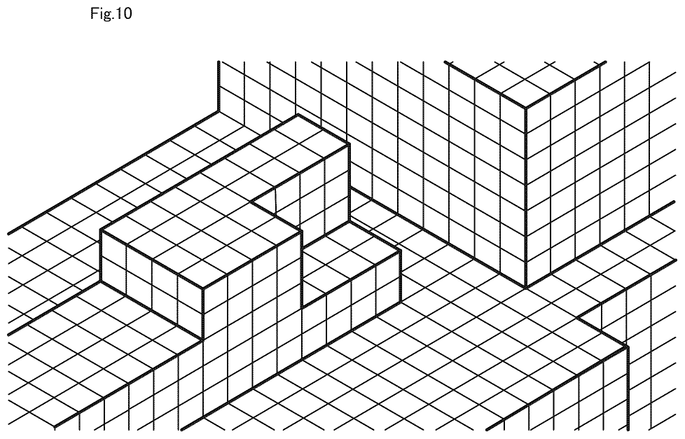

It is possible to change the shape of a voxel object by changing voxel data of voxels. FIG. 9 and FIG. 10 are views showing before and after the removal of a portion of the terrain object shown in FIG. 8. That is, when the hatched portion of the terrain object shown in FIG. 9 is broken, the terrain object changes to a shape as shown in FIG. 10. In such a case, the game system 1 can easily delete the terrain object by rewriting the voxel data described below so as to indicate that the terrain object is absent for voxels in the hatched portion. Note that also when making an addition to the terrain object, as when deleting the terrain object, the game system 1 can easily change the shape of the terrain object by changing the voxel data of voxels.

Thus, the game system 1 can freely change the shape of a voxel object by rewriting the voxel data. For example, the shape of a terrain object may be changed as a result of the terrain object in a game being broken for some reason (e.g., the player object striking the terrain object). In such a case, the game system 1 can freely change the shape of the terrain object by changing the voxel data used to generate the terrain object, rather than directly changing data representing the outer shape of the terrain object (e.g., the mesh to be described below).

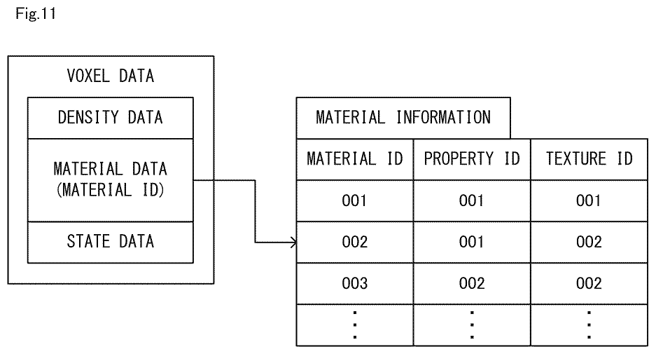

FIG. 11 is a diagram showing an example of content of voxel data. Here, in the exemplary embodiment, the game space can be divided into a plurality of voxels arranged in a grid pattern. The game system 1 stores voxel data for each voxel in the game space so that the voxel data is associated with the voxel. The voxel data represents, for example, the presence/absence of a voxel object in the voxel corresponding to the voxel data.

As shown in FIG. 11, voxel data includes density data. The density data represents the density, which is an index used to define the shape of a voxel object in the voxel corresponding to the voxel data (specifically, the shape defined by the mesh to be described below). As will be described in detail below, the position and the shape of the surface of the voxel object (e.g., the mesh to be described below) are determined based on this density. In other words, in the exemplary embodiment, this density is used to generate a mesh that defines the surface of the voxel object.

In the exemplary embodiment, the density can take an integer value in the range from the lower limit value (e.g., 0) to the upper limit value (e.g., 255). In the exemplary embodiment, the game system 1 determines the shape of a voxel object based on the density such that the proportion of the volume to be occupied by the voxel object in a voxel tends to be higher when the density value set for the voxel is higher and that the proportion tends to be lower when the density value is lower. Thus, the density is an index that affects the proportion of the volume to be occupied by the voxel object in the voxel. The density can also be said to be an index that represents the degree to which an object is included in the region defined by each voxel. For example, if the density is 0, there is no voxel object in the voxel, if the density is 255, the inside of the voxel is entirely the voxel object, and if the density is between 0 and 255, the inside of the voxel is occupied by the voxel object to the proportion that is determined based on the density value. Then, the shape of the mesh, e.g., the shape of the voxel object, can determined based on the density. Note however that the voxel object generated based on the density does not need to have a volume that exactly matches the proportion represented by the density. For example, the method of generating a voxel object as shown in FIG. 8 and the method of generating a voxel object as shown in FIG. 15 may differ in the volume of the voxel object, even if they are based on the same density.

In other embodiments, the density may indicate either a state in which the voxel object occupies the entirety of the region within the voxel or a state in which no voxel object is included in the region within the voxel. For example, the density data may be data that can take only 0 or 1.

As shown in FIG. 11, voxel data includes material data. The material data represents the material (in other words, the substance) of the voxel object generated by the voxel data. Here, in the exemplary embodiment, materials such as sand, rock and soil, for example, are set for voxel objects. That is, in the exemplary embodiment, a plurality of types of materials are provided as materials that can be set for a voxel object, and one of the materials is set for a voxel object.

As shown in FIG. 11, in the exemplary embodiment, the material data represents the identification information of the material (referred to as “material ID”). In the exemplary embodiment, the game system 1 stores material information representing the property and the texture of the material for each material provided in the game. In the exemplary embodiment, the material information represents associations between the material ID, the property of the material and the appearance (specifically, the texture) of the material. Specifically, the material information is information that represents associations between the material ID, identification information of the property of the material (referred to as “property ID”) and identification information of the texture of the material (referred to as “texture ID”) (see FIG. 11).

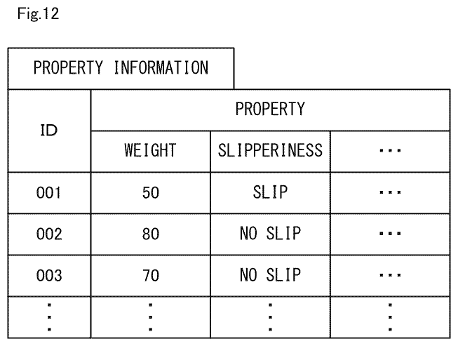

FIG. 12 is a diagram showing an example of property information representing properties of materials. As shown in FIG. 12, the game system 1 stores property information that associates each property ID with information that represents the content of the property represented by the property ID. A property of a material is a property of a voxel object for which the material is set in the game, and it may be information such as weight or slipperiness shown in FIG. 12, for example. Note that there is no limitation on the specific content of property. For example, the following information may be set as properties of a material.
Temperature
Breakability (e.g., the number of times of impact impartation needed to break a voxel object)
Whether another object can be bonded to a voxel object
Amount of hit points to be regained by the player character when the player character breaks a voxel object
Amount of in-game currency to be gained by the player character when the player character breaks a voxel object

Note that there is no limitation on the specific content of the property to be set for a material. In other embodiments, information different from those listed above may be set as information that represents a property of a material.

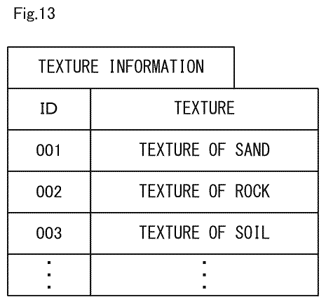

FIG. 13 is a diagram showing an example of texture information representing textures of materials. As shown in FIG. 13, the game system 1 stores texture information that associates the texture ID with the texture represented by the texture ID.

Note that in addition to information of texture, any information regarding the color and/or pattern may be set as data that defines the appearance of a voxel object. For example, a pattern of cracks may be set as information regarding the appearance of a voxel object. By using such a pattern, the game system 1 can generate an image of a voxel object that represents the appearance of cracks.

As described above, in the exemplary embodiment, the material data defines, by the material ID, the property of the voxel object and the texture used for the voxel object. For example, when the material ID represented by the material data included in the voxel data is “002”, the property represented by the property ID “001” that is associated with the material ID in the material information is set as the property of the voxel object corresponding to the voxel data (see arrow shown in FIG. 11). In this case, the texture that is represented by the texture ID “002” associated with the material ID in the material information is applied to the voxel object corresponding to the voxel data (see arrow shown in FIG. 11).

As described above, in the exemplary embodiment, the game system 1 separately manages the property and the texture of the material. Therefore, in the exemplary embodiment, it is possible to easily set a plurality of types of materials having the same property but having different appearances (e.g., different textures) or set a plurality of types of materials having different properties but having the same appearance.

Note that the material data may be any data with which it is possible to identify the property and/or the texture of the material. For example, in other embodiments, the material data may represent the property ID and the texture ID, or may have a data structure that actually includes data representing the property and the texture of the material.

The material data may further represent information related to the material other than the property and the texture described above. For example, the material data may include special effect data that represents the special effect to be triggered upon satisfaction of a special effect triggering condition set for the voxel object (e.g., a portion of the voxel object being broken, or the character stepping on the voxel object). Note that the special effect data may be data that represents a special effect image (e.g., a special effect image showing the voxel object being broken), or may be data that represents a special effect sound (a sound of footstep when the character walks on the voxel object).

As shown in FIG. 11, the voxel data includes state data that represents the state of the voxel object. There is no limitation on the specific content of the state data. For example, the state data may be data that represents whether the voxel object is in a wet state, or may be data that represents the amount of damage applied to the voxel object. The content of the state data may be updated during the game.

### 2-2. Mesh

In the exemplary embodiment, the surface of the voxel object is represented by a mesh. A mesh is a set of faces (specifically, polygons) placed in the game space. In the exemplary embodiment, the game system 1 generates a mesh for the voxel object based on the voxel data of each voxel set in the game space. An example of how a mesh is generated based on voxel data will now be described.

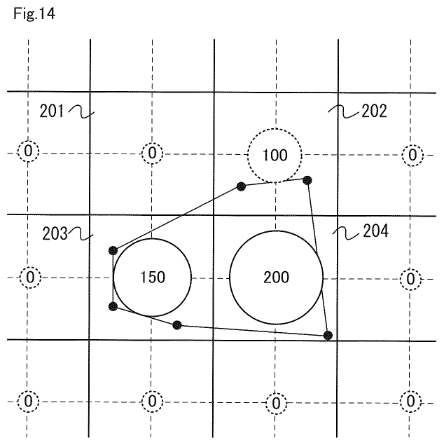

FIG. 14 is a diagram showing an example method for generating a mesh. Note that in FIG. 14, voxels and meshes are represented in two dimensions for the purpose of making the drawing easier to understand and for the sake of discussion, but in practice, a three-dimensional mesh is generated based on voxels in a three-dimensional space.

As described above, in the exemplary embodiment, the density set for the voxel is in the range of 0 to 255. In the exemplary embodiment, voxels with densities equal to or greater than the reference threshold value are considered to be inside the voxel object, and voxels with densities less than the reference threshold value are considered to be outside the voxel object. It is not necessary to define only voxels with a density of 0 as being outside the voxel object (e.g., reference threshold value=1), and the reference threshold value may be set to 128, for example. In the example shown in FIG. 14, a voxel 201 and the other outer voxels have a density of 0, a voxel 202 has a density of 100, which is less than the reference threshold value, and voxels 203 and 204 have densities of 150 and 200, which are greater than the reference threshold value (e.g., 128). In the exemplary embodiment, the game system 1 generates vertices between those voxels whose densities are equal to or greater than the reference threshold value and those voxels whose densities are less than the reference threshold value. Specifically, for each region (region delimited by dotted lines) that straddles eight (four in the figure) adjacent voxels, it is determined whether or not to generate a vertex. That is, a vertex is generated in each region that straddles both a voxel whose density is equal to or greater than the reference threshold value and a voxel whose density is less than the reference threshold value. Then, a polygon mesh is generated by connecting together adjacent vertices if the connection (the boundary between the regions including the vertices) passes through a voxel whose density is equal to or greater than the reference threshold value and a voxel whose density is less than the reference threshold value. The coordinates of each vertex are determined by comparing densities of adjacent voxels and interpolating based on the difference in density for each of the XYZ axes. In this process, the coordinates can be further calculated based on the normal information. The normal information may be stored in advance for at least some of the voxels, or if not stored, the normal information may also be calculated based on densities between adjacent voxels. Note that in FIG. 14, the density of the voxel 202 is less than the reference threshold value, the voxel 202 is treated as being outside the voxel object in the determination of the presence/absence of a vertex, but the density value itself of the voxel 202 is used to calculate the coordinates of the vertices generated. If the reference threshold value were set to a value lower than the density of the voxel 202, it would result in an increase in the vertices on the upper right side and the upper left side in the voxel 202 of FIG. 14.

By generating a polygon mesh as described above, it is possible to generate a shape whose volume is based on (e.g., reflects) the density of each voxel to some extent. Note however that depending on the relationship with neighboring voxels, it is possible that a voxel with a density of 0 may partially include a region inside the voxel object, or a voxel with a density of 255 may partially include a region outside the voxel object. Since voxels with densities less than the reference threshold value are treated as being outside the voxel object in the exemplary embodiment, there are fewer vertices as compared with a case where those voxels are treated as being inside the voxel object, the volume will be smaller accordingly. That is, there is no need to calculate the polygon mesh so that the volume strictly corresponds to the density value.

FIG. 15 shows an example of a game image including a terrain object. In the exemplary embodiment, by generating a mesh as described above, the voxel object can be made in a shape with complicated irregularities compared to the cubic voxels, for example.

Note that there is no limitation on the method of generating a mesh based on voxel data. For example, in other embodiments, if the density of the voxel data is greater than a predetermined value, a mesh may be generated so that a cube is placed in the voxel (see FIG. 8).

For each face of the mesh generated as described above, the game system 1 determines the appearance (e.g., color and/or pattern) of each such face according to the material identified by the voxel data. Specifically, the game system 1 determines the texture to be used for rendering each face of the mesh based on the voxel data, and maps the determined texture to each face to generate an image of the voxel object. Note that the texture to be mapped to each face of the mesh is determined based on the voxel data of the voxel used to generate the face (which will be referred to as the target voxel) among the voxels where the voxel object exists. Note that the target voxel is, for example, one or more voxels located around the face, although it depends on the mesh generation method. That is, the texture mapped to a face of the mesh is determined to be a texture corresponding to the material set for one or more voxels placed around the face.

Note that in other embodiments, one voxel data may include multiple types (e.g., two types) of material data. In such a case, the voxel data includes ratio data related to the multiple types of material data. The ratio data is data for determining the texture to be used for the voxel object, and represents the ratio by which each of the materials (specifically, the texture corresponding to the material) represented by the multiple types of material data influences the appearance (specifically, the color and/or pattern) of the voxel object. When determining the texture to be mapped to each face of the mesh, the texture is determined based on various data (specifically, density data, multiple types of material data and ratio data) included in the voxel data of the target voxel. For example, when multiple types of materials are set for a target voxel corresponding to one face, a texture corresponding to the (one type of) material with the greatest degree of influence may be used while taking the ratio into consideration, or textures corresponding to multiple types of materials may be used while taking the ratio into consideration.

In other embodiments, there may be both voxel objects for which voxel data including one type of material data is used, and voxel objects for which voxel data including two types of material data is used.

### 2-3. Deformation of Non-Player Character

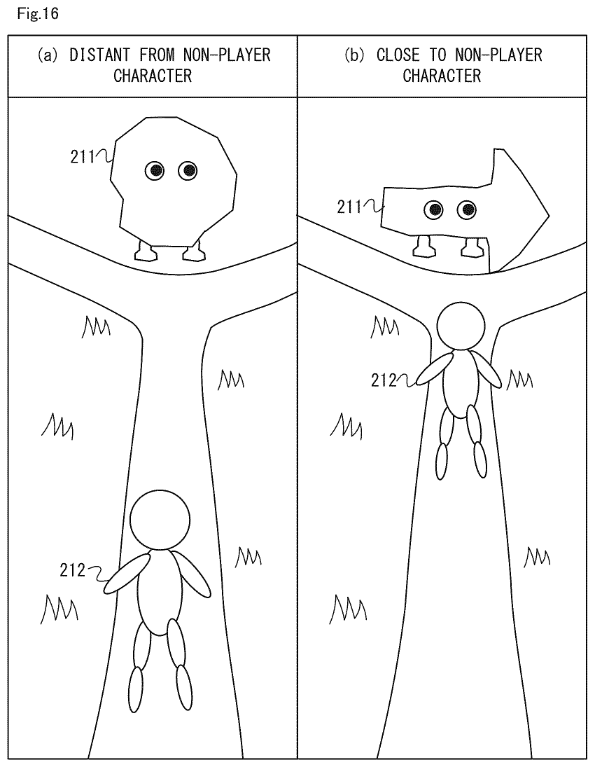

With reference to FIG. 16 to FIG. 21, a process of deforming a non-player character as a voxel object will be described. FIG. 16 is a diagram showing an example of a state where a non-player character deforms. In the exemplary embodiment, the game system 1 places a non-player character 211 in the game space. As shown in (a) of FIG. 16, when a player character 212 is distant from the non-player character 211 during the game, the non-player character 211 has a basic shape. In the exemplary embodiment, the non-player character 211 is a character imitating a rock, and the basic shape is a shape like a rock. Note that the basic shape may be any shape.

Meanwhile, as shown in (b) of FIG. 16, when the player character 212 is located close to the non-player character 211, the non-player character 211 deforms from the basic shape to a suggestion shape. The suggestion shape is a shape that suggests any information regarding the game to the user (or the player). In the example shown in FIG. 16, the suggestion shape is a shape of a rightward arrow, and suggests that the player character 212 should proceed to the right (e.g., when proceeding to the right, the player character 212 can make the story of the game progress, or acquire an important item). Other examples of the suggestion shape will be described later. In the exemplary embodiment, the suggestion shape represents a letter or a mark that suggests information regarding the game.

As described above, in the exemplary embodiment, since the shape of the non-player character 211 itself deforms, the non-player character 211 can attract more attention of the user. This allows the user to be more easily aware of the information regarding the game being suggested. Furthermore, in the exemplary embodiment, since the information is suggested by the shape of the non-player character 211 itself, the user can obtain the information even when the player character 212 does not have a conversation with the non-player character 211 (however, the user may obtain more information through a conversation), for example.

Hereinafter the non-player character deformation process will be described in detail. In the exemplary embodiment, the deformation process is executed according to a deformation condition defined in the game program having been satisfied. In the exemplary embodiment, the deformation condition is a condition regarding the positional relationship between the non-player character 211 and the player character 212. Specifically, the deformation condition is that the player character 212 is located within a determination range in the vicinity of the non-player character 211. The determination range in the exemplary embodiment is a range of a reference distance from the position of the non-player character 211. That is, when the player character 212 is located within the reference distance from the non-player character 211, the game system 1 deforms the non-player character 211 from the basic shape to the suggestion shape. Thus, since the non-player character located near the player character 212 can be deformed, the user is more likely to be aware of the deformation of the non-player character.

Note that the deformation condition is not limited to the above condition, and may be other conditions regarding the positional relationship between the non-player character and the player character. For example, the determination range may be a range that is determined based on the position of the non-player character. Specifically, the determination range may be a field-of-view range of the non-player character (more specifically, a range of a sector shape when the position of the non-player character is at the center of a circle). When the non-player character is located within a certain area (e.g., an area in a room or an area on a stage), the determination range may be a range within the area. The deformation condition may be a condition regarding the direction of the player character with respect to the non-player character. Specifically, the deformation condition may be that the player character faces the non-player character. In this case, for example, the game system 1 may determine that the player character faces the non-player character when an angle formed by the forward direction of the player character and the direction from the player character to the non-player character is not greater than a predetermined angle, and may determine that the player character does not face the non-player character when the angle is greater than the predetermined angle.

In other embodiments, the deformation condition may be a condition obtained by combining the condition regarding the positions of the non-player character and the player character, and the condition regarding the direction of the player character with respect to the non-player character. For example, the deformation condition may be that the player character is located within the determination range based on the non-player character and the player character faces the non-player character. Alternatively, for example, the deformation condition may be that one of the above conditions, i.e., the player character being located within the determination range based on the non-player character, or the player character facing the non-player character, is satisfied.

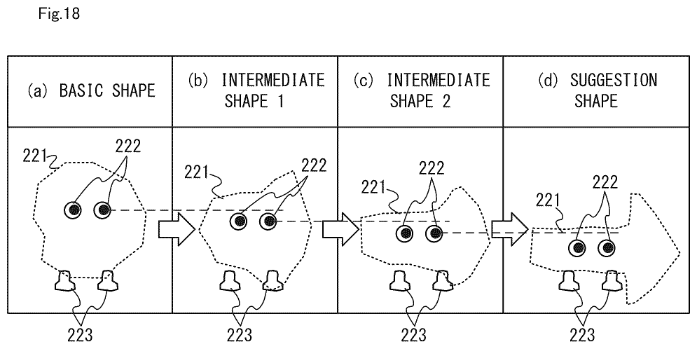

When the deformation condition has been satisfied, the game system 1 deforms the non-player character 211 from the basic shape to the suggestion shape. In the exemplary embodiment, the non-player character 211 has a body object, an eye object, and a foot object (see FIG. 16 and FIG. 18). In the exemplary embodiment, the game system 1 deforms the non-player character by changing the shape of the body object.

In the exemplary embodiment, the body object is a voxel object. Note that in the exemplary embodiment, the shape of the body object, which is a voxel object included in the non-player character, is defined by voxel data regarding a voxel different from the terrain object described above. That is, a voxel space regarding the non-player character (referred to as “sub-voxel space”) is a voxel space that is set separately from a voxel space regarding the terrain object (referred to as “main-voxel space”). The sub-voxel space is set in a part of the game space (or a part of the main-voxel space), and the non-player character is placed in the sub-voxel space. The size and the direction of a voxel (e.g., the direction of each side of the voxel) in the sub-voxel space may be different from those of a voxel in the main-voxel space. For example, by setting a sub-voxel space that defines a voxel, each side of which has a length shorter than that of a voxel in the main-voxel space, it is possible to represent the shape of the non-player character more minutely than the shape of the terrain object based on the main-voxel space. Further, the game system 1 changes the position or the attitude of the sub-voxel space in the game space, thereby changing the position or the attitude of the non-player character (more exactly, the position or the attitude in the game space). When a plurality of non-player characters are placed in the game space, the game system 1 sets a sub-voxel space for each non-player character in the game space.

Note that in other embodiments, in addition to the body object, the eye object and the foot object may also be voxel objects (e.g., the entirety of the non-player character may be a voxel object). In other embodiments, the shape of the non-player character may be defined by the voxel data of the main-voxel space described above. In other embodiments, the non-player character may not necessarily be a voxel object.

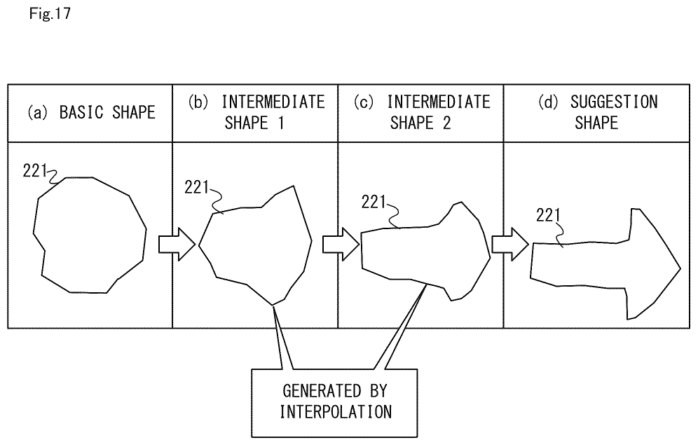

FIG. 17 is a diagram showing an example of a state where a body object of a non-player character deforms. As shown in FIG. 17, in the exemplary embodiment, the game system 1 gradually deforms the non-player character (specifically, the body object 221) from the basic shape to the suggestion shape. Specifically, the game system 1 stores the basic shape and the suggestion shape of the body object 221 in advance. When executing the deformation process, the game system 1 performs interpolation between the basic shape and the suggestion shape, thereby generating a shape in the middle of deformation (referred to as “intermediate shape”). In the example shown in FIG. 17, deformation from the basic shape to the suggestion shape is performed in three stages. Therefore, the game system 1 generates two intermediate shapes by interpolation between the basic shape and the suggestion shape. Note that there is no limitation on the number of stages of deformation. For example, the game system 1 may generate nine intermediate shapes to perform deformation over ten frames.

The game system 1 changes the shape of the body object 221 from the basic shape to the suggestion shape via the intermediate shapes, according to the lapse of time (e.g., for each predetermined number of frames), thereby representing a state where the body object 221 gradually deforms. The gradually deforming non-player character 211 is shown to the user as described above, whereby the non-player character 211 can more easily attract the attention of the user.

Note that in the exemplary embodiment, since the body object 221 is a voxel object, data representing the shapes of the body object 221 (e.g., the basic shape, the intermediate shape, and the suggestion shape) are voxel data. The game system 1 performs interpolation between the basic shape and the suggestion shape with respect to the density value represented by the voxel data of each voxel in the sub-voxel space regarding the non-player character 211, thereby easily calculating voxel data (more specifically, the density value in the voxel data) representing the intermediate shape.

As described above, in the exemplary embodiment, the shape of the non-player character is determined based on the voxel data of each voxel set in the voxel space. The game system 1 performs an interpolation process by using the voxel data representing the basic shape and the voxel data representing the suggestion shape, thereby gradually deforming the non-player character from the basic shape to the suggestion shape. Thus, in the exemplary embodiment, the voxel data allows the interpolation process to be easily performed. Note that the specific method for interpolation may be any method such as linear interpolation.

FIG. 18 is a diagram showing an example of a state where an eye object and a foot object change when the non-player character deforms. Note that in FIG. 18 the body object 221 is represented by a dotted line in order to make the drawing easier to see. As shown in FIG. 18, in the exemplary embodiment, the position of the eye object 222 differs between the state where the non-player character 211 has the basic shape and the state where it has the suggestion shape. Therefore, the game system 1 changes the position of the eye object 222 (specifically, the position of a joint corresponding to the eye object 222) according to deformation of the body object 221 in the deformation process. In the example shown in FIG. 18, the position of the eye object 222 gradually shifts downward as the body object 221 deforms.

The game system 1 stores in advance the position of the eye object 222 in the basic shape and the position of the eye object 222 in the suggestion shape. When performing the deformation process, the game system 1 performs interpolation between the position of the eye object 222 in the basic shape and the position of the eye object 222 in the suggestion shape, thereby calculating the position of the eye object 222 in the intermediate shape. Therefore, in the state where the body object 221 has the intermediate shape, the eye object 222 is placed at a position between the position in the basic shape and the position in the suggestion shape (see FIG. 18).

Note that in the exemplary embodiment, the interpolation process for the body object 221 to generate an intermediate shape is a process of performing interpolation for the density represented by the voxel data, while the interpolation process for the eye object 222 is a process of performing interpolation for the position. Thus, in the exemplary embodiment, the game system 1 performs the interpolation process for the eye object 222 independently of the interpolation process for the body object 221.

As described above, in the exemplary embodiment, the non-player character has a first part (e.g., the body object 221) that deforms from the basic shape to the suggestion shape, and a second part (e.g., the eye object 222) that is different from the first part. The game system 1 changes the position of the second part according to deformation of the first part from the basic shape to the suggestion shape. This reduces the risk that the position of the second part in the suggestion shape becomes unnatural and thereby the appearance of the non-player character becomes unnatural. Note that in other embodiments, the game system 1 may not change the positions of the parts other than the first part in the deformation process.

Further, in the exemplary embodiment, the game system 1 gradually changes the position of the second part according to gradual deformation of the first part from the basic shape to the suggestion shape (see FIG. 18). Thus, the risk that the appearance of the non-player character becomes unnatural can be reduced not only in the suggestion shape but also in the intermediate shape. Note that in other embodiments, the game system 1 may not gradually change the position of the eye object when the body object gradually deforms from the basic shape to the suggestion shape. That is, the game system 1 may not calculate the position of the eye object in the intermediate shape, and may change the position of the eye object according to the body object having deformed to the suggestion shape.

Note that in the exemplary embodiment, the second part whose position changes during the deformation from the basic shape to the suggestion shape is the eye object 222 of the non-player character 211, but in other embodiments, the second part may be any part of the non-player character. For example, in other embodiments, the game system 1 may change the position of an ear object, a mouth object, a hand object, or a foot object of the non-player character during the deformation from the basic shape to the suggestion shape.

In the exemplary embodiment, the non-player character 211 has, in addition to the joint corresponding to the eye object 222, joints for the game system 1 to control the motion of the non-player character 211 (e.g., a joint corresponding to the body object 221, and a joint corresponding to the foot object 223). In the deformation process, the game system 1 also changes the positions of the joints. Note that, as for the joints other than the joint corresponding to the eye object 222, the game system 1 stores the positions of these joints in the basic shape and the suggestion shape. The positions of these joints in the intermediate shape are calculated by the same method as that for the joint corresponding to the eye object 222. However, in other embodiments, the positions of these joints in the intermediate shape may not necessarily be calculated, like the joint corresponding to the eye object 222.

As shown in FIG. 18, in the exemplary embodiment, the position of the foot object 223 in the basic shape is the same as that in the suggestion shape. This is to avoid the inconvenience that the deformation from the basic shape to the suggestion shape causes the foot object 223 to be embedded in the ground in the game space or to be floated above the ground. Therefore, in the exemplary embodiment, interpolation is not performed for the foot object 223. However, in other embodiments, like the eye object 222, the position of the foot object 223 in the basic shape may be different from that in the suggestion shape, and the position of the foot object 223 may be gradually changed during the deformation from the basic shape to the suggestion shape.

Note that in the exemplary embodiment, the eye object 222 and the foot object 223 are not voxel objects, but the game system 1 manages the positions of these objects (precisely, the positions with reference to the non-player character) by using the same coordinate system as that for the sub-voxel space.

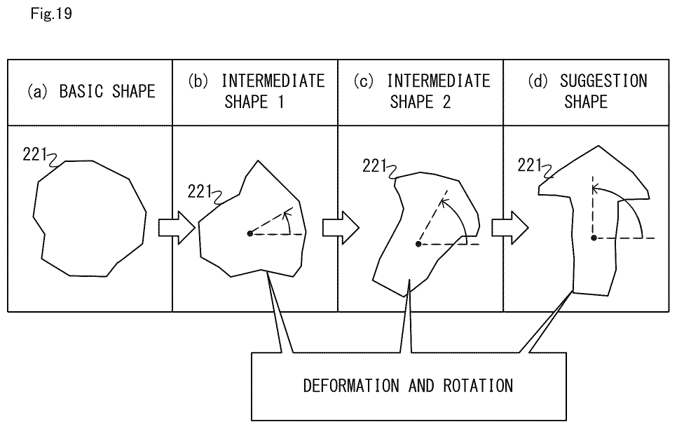

In FIG. 16 to FIG. 18, the case where the suggestion shape is a rightward arrow has been described as an example. In the exemplary embodiment, the game system 1 can also deform the non-player character 211 with the suggestion shape that is an arrow pointing a direction other than right. Hereinafter, a deformation process in which the suggestion shape is an upward arrow will be described with reference to FIG. 19.

FIG. 19 shows an example of deformation in which the suggestion shape is an upward arrow. As shown in FIG. 19, when the suggestion shape is an upward arrow, as in the case where the suggestion shape is a rightward arrow, the game system 1 gradually deforms the body object 221 from the basic shape to the suggestion shape. Here, in the exemplary embodiment, the game system 1 generates an intermediate shape and a suggestion shape in the case where the suggestion shape is an upward arrow, by using the suggestion shape that is a rightward arrow.

In the example shown in FIG. 19, the game system 1 first performs interpolation between a suggestion shape (e.g., a rightward arrow) and a basic shape, which are prepared in advance, thereby generating a body object 221 having the same intermediate shape as in the case of generating a suggestion shape that is a rightward arrow (e.g., an intermediate shape regarding a rightward arrow). Next, the game system 1 rotates the body object 221 having the intermediate shape regarding the rightward arrow, thereby generating a body object 221 having an intermediate shape in the case where a suggestion shape represents an upward arrow ((b) and (c) of FIG. 19).

Note that the angle of rotating the body object 221 having the intermediate shape regarding the rightward arrow is determined to an angle based on: an angle formed between the direction (e.g., upward direction) of the arrow of the suggestion shape to be generated and the direction of the suggestion shape (here, the rightward arrow) stored in advance; and the number of stages of intermediate shapes in deformation from the basic shape to the suggestion shape. In the example shown in FIG. 19, the angle formed between the direction of the arrow of the suggestion shape to be generated and the direction of the suggestion shape stored in advance is 90°, and the deformation from the basic shape to the suggestion shape is performed in three stages. Therefore, the body object 221 having the first-stage intermediate shape ((b) of FIG. 19) is obtained by rotating the body object 221 having the first intermediate shape regarding the rightward arrow by 300 (=90°× ⅓) in a direction approaching the upward direction. Further, the body object 221 having the second-stage intermediate shape ((c) of FIG. 19) is obtained by rotating the body object 221 having the second intermediate shape regarding the rightward arrow by 60° (=90°×⅔) in a direction approaching the upward direction. Moreover, the body object 221 having the suggestion shape of the upward arrow is obtained by rotating the body object 221 having the suggestion shape of the rightward arrow by 90° in a direction approaching the upward direction.

Also in the case where an arrow other than the rightward arrow is used as the suggestion shape, as in the case of using the rightward arrow as the suggestion shape, the game system 1 determines the positions of the eye object 222 and the foot object 223. That is, the position of the eye object 222 in the intermediate shape is calculated through interpolation between the position of the eye object 222 in the basic shape and the position of the eye object 222 in the suggestion shape. Note that the final position of the eye object 222 in the suggestion shape may be varied among the suggestion shapes having different directions of arrows. That is, the game system 1 may store the position of the eye object 222 for each of the suggestion shapes having different directions of arrows, and may calculate the position of the eye object 222 in the intermediate shape through interpolation between the position in the basic shape and the position in the suggestion shape. The foot object 223 is placed at a position determined in the game program.

As described above, in the exemplary embodiment, the game system 1 deforms the non-player character from the basic shape to the suggestion shape that is an arrow, and rotates the non-player character (specifically, rotates a suggestion shape prepared in advance or an intermediate shape generated based on the suggestion shape prepared in advance) to change the direction represented by the suggestion shape. Therefore, it is not necessary to prepare a suggestion shape for each allow direction, whereby labor for generating data of suggestion shapes can be reduced. Further, it is not necessary for the game system 1 to store a suggestion shape for each arrow direction, whereby the amount of data of suggestion shapes to be prepared in advance can be reduced. Note that also when the basic shape is an arrow pointing a certain direction and the suggestion shape is an arrow pointing another direction, the game system 1 may generate an intermediate shape through rotation as described above. In this case, since the intermediate shape is generated by rotating the basic shape while deformation by interpolation is not (or hardly) performed, the intermediate shape is also an arrow, thereby improving the appearance of the intermediate shape.

In the example shown in FIG. 16 to FIG. 19, the suggestion shape of the non-player character 211 is a mark representing a direction (e.g., an arrow). Here, the suggestion shape may be a letter representing a direction (e.g., “R” representing right). This enables the user to easily and intuitively recognize the direction in which the player character 212 should proceed.

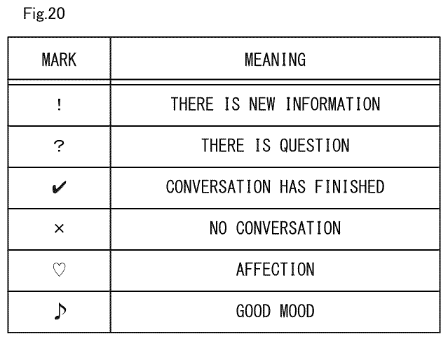

Note that the game system 1 may deform the non-player character 211 into a suggestion shape representing another letter or mark, in addition to the suggestion shape that is an arrow. FIG. 20 is a diagram showing examples of marks that the suggestion shape represents, and the meanings of the respective marks. The game system 1 may deform the non-player character 211 so as to have a suggestion shape imitating any of the various marks shown in FIG. 20. For example, a suggestion shape imitating an exclamation mark (“!”) may suggest that the non-player character 211 has new information (e.g., the player character 212 can acquire the information through a conversation). A suggestion shape imitating a question mark (“?”) may suggest that the non-player character 211 has a question to the player character 212 (e.g., when the player character 212 talks to the non-player character 211, the question is made). A suggestion shape imitating a check mark may suggest that the conversation with the non-player character 211 has finished. A suggestion shape imitating a mark “x” may suggest that the non-player character 211 does not talk to the player character 212. A suggestion shape imitating a heart mark may suggest that the non-player character 211 likes the player character 212 (e.g., when the player character 212 talks to the non-player character 211 in this state, the player character 212 can get an item). A suggestion shape imitating a musical note mark may suggest that the non-player character 211 is in a good mood (e.g., when the player character 212 talks to the non-player character 211 in this state, the player character 212 can get information). Like the heart mark and the musical note mark described above, the suggestion shape may suggest the state of the non-player character 211 related to the game.

The game system 1 may change the suggestion shape of the non-player character 211 according to the game state. For example, the direction of an arrow as the suggestion shape may be changed according to the progress state of the story of the game (e.g., according to change in the direction in which the player character 212 should proceed). Moreover, for example, in the state where the player character 212 does not yet have a conversation with the non-player character 211, the suggestion shape is an exclamation mark. In the state where the player character 212 has had a conversation with the non-player character 211, the suggestion shape may be changed to a check mark.

In the exemplary embodiment, the player character 212 can have a conversation with the non-player character 211. That is, in the state where the player character 212 is located near the non-player character 211, if an instruction input to make a conversation is performed by the user, the player character 212 has a conversation with the non-player character 211. When the conversation is performed, the game system 1 displays a message indicating the content of the conversation of the non-player character 211. Note that in other embodiments, the message of the non-player character 211 may be displayed when the player character 212 approaches the non-player character 211, when the player character 212 faces the non-player character 211, or when the deformation condition is satisfied.

In the exemplary embodiment, the content of the message of the non-player character 211 relates to the suggestion shape of the non-player character 211. That is, it can be said that the suggestion shape of the non-player character 211 suggests the content of the message of the non-player character 211. The game system 1 displays the message (specifically, the message from the non-player character 211) indicating the content related to the suggestion shape, according to the player character 212 having a conversation with the non-player character 211. For example, when the suggestion shape represents the arrow described above, a message to be displayed by a conversation between the player character 212 and the non-player character 211 is a sentence that gives a direction to the player character 212 (e.g., “Go this way and you can reach the goal”, “Turn to the right and you can get an item”, etc.). Further, for example, when the suggestion shape represents a question mark (“?”), the message is a question to the player character 212 (e.g., “Is there anything you want?”, “Do you have an item of ∘ ∘?”, etc.). As described above, according to the exemplary embodiment, information that the suggestion shape cannot sufficiently inform to the user (e.g., more specific information) can be informed to the user through the message. Further, the suggestion shape enables the user to guess or roughly grasp the content of the conversation, and therefore enables the user to determine whether or not to have the conversion with the non-player character 211.

Note that there is no limitation on the specific content of a display condition for displaying the above message. For example, in other embodiments, the game system 1 may display the above message according to the deformation condition having been satisfied. That is, the message may be displayed when the non-player character 211 deforms to the corresponding suggestion shape. In this case, as in the exemplary embodiment, information that the suggestion shape cannot sufficiently inform to the user can be informed through the message.

In the exemplary embodiment, the game system 1 controls the motion of the non-player character 211. There is no limitation on the specific content of the motion of the non-player character 211. For example, the game system 1 controls the non-player character 211 so that the non-player character 211 performs a motion of turning its body to the left or right or swinging up and down while it is standing, or a motion of walking.

In the exemplary embodiment, the game system 1 causes the non-player character 211 to perform the same motion when the non-player character 211 has the basic shape and when the non-player character 211 has the suggestion shape. In the exemplary embodiment, as for the joints of the non-player character 211, the number and the connection relationship of the joints are not changed between the state where it has the basic shape and the state where it has the suggestion shape, although the positions of the joints can be changed. Therefore, regardless of whether the non-player character 211 has the basic shape or the suggestion shape, the game system 1 can cause the non-player character 211 to move in the same way by controlling the joints in the same manner.

Further, as described above, in the exemplary embodiment, even when the non-player character 211 has the intermediate shape, the game system 1 calculates the positions of the joints according to the intermediate shape at that time. Therefore, in the exemplary embodiment, the game system 1 can cause the non-player character 211 to continue the motion even during deformation from the basic shape to the suggestion shape.

In the exemplary embodiment, when a cancellation condition defined in the game program has been satisfied after the above deformation condition was satisfied, the game system 1 restores the non-player character 211 from the suggestion shape to the basic shape. Note that in the exemplary embodiment, also in the case of deformation from the suggestion shape to the basic shape, the game system 1 gradually deforms the non-player character 211 from the suggestion shape to the basic shape, as in the case of deformation from the basic shape to the suggestion shape. Further, like the deformation condition, the cancellation condition is a condition regarding the positional relationship between the non-player character 211 and the player character 212. Specifically, the cancellation condition is that the player character 212 goes out of a range of a predetermined cancellation distance from the position of the non-player character 211. The cancellation distance is a distance equal to or longer than the reference distance regarding the above deformation condition.

The cancellation condition is not limited to the above condition, and may be another condition regarding the positional relationship between the non-player character 211 and the player character 212. For example, when the deformation condition is that the player character 212 is located within a predetermined area (e.g., an area in a room or an area on a stage) determined based on the non-player character 211, the cancellation condition may be that the player character 212 goes out of the predetermined area. Further, for example, when the deformation condition is that the player character 212 faces the non-player character 211, the cancellation condition may be that the player character 212 does not face the non-player character 211.

As described above, the game system 1 deforms the non-player character 211 from the suggestion shape to the basic shape in accordance with the cancellation condition including that the player character 212 is located outside the range that is based on the non-player character 211 and is the same as or different from the determination range (in the exemplary embodiment, the range of the cancellation distance from the non-player character 211), and/or that the player character 212 does not face the non-player character 211. Thus, the shape of the non-player character 211 can be restored to the basic shape. Therefore, the non-player character 211 again deforms to the suggestion shape when the deformation condition is again satisfied, whereby the non-player character 211 can again attract the attention of the user. Note that in other embodiments, the cancellation condition may not necessarily to be set, and the non-player character 211 once having deformed to the suggestion shape may not necessarily be restored to the original basic shape.

Note that the cancellation condition is a condition that is not satisfied when the deformation condition is satisfied. However, the cancellation condition may not necessarily be a condition that is always satisfied when the deformation condition is not satisfied. For example, in the exemplary embodiment, the cancellation condition is not necessarily satisfied immediately after the player character 212 goes out of the determination range that is the range of the reference distance from the non-player character 211 (e.g., the cancellation distance may not necessarily be the same as the reference distance). In the exemplary embodiment, the game system 1 sets the cancellation distance to a distance longer than the reference distance so that the cancellation condition is not satisfied immediately after the player character 212 goes out of the determination range. This makes the cancellation condition not likely to be readily satisfied when the player character 212 repeatedly goes in and out of the determination range. As a result, it is possible to reduce the risk that deformation between the basic shape and the suggestion shape is frequently repeated.

In the exemplary embodiment, since the non-player character 211 (specifically, the body object 221) is a voxel object, the non-player character 211 can be deleted (or broken) during the game, like the terrain object described above. Specifically, if any impact is imparted to the non-player character 211, the game system 1 deletes a part of the body object 221 by updating the voxel data of the body object 221 (more specifically, the density data described above). For example, the game system 1 deletes a part of the non-player character 211 according to a motion of the player character 212 (e.g., a motion of punching the non-player character 211, or a motion of hitting another object against the non-player character 211). Thus, the player can change the shape of the non-player character 211 by operating the player character 212.

When a part of the non-player character 211 (specifically, the body object 221) has been deleted as described above, the game system 1 restores the shape of the non-player character 211 to the original shape according to the lapse of time. Specifically, the game system 1 gradually changes the voxel data (more specifically, the density data) of the body object 221 according to the lapse of time so as to be restored to the value before the deletion. Therefore, even when the non-player character 211 has been deleted due to the motion of the player character 212 or the like, the non-player character 211 is gradually restored to the original shape. Thus, the player can enjoy repeatedly deforming the non-player character 211. Further, since the shape of the partially-deleted non-player character 211 is restored to the original shape, the player is allowed to recognize that the non-player character 211 is a character having a nature of deforming. Since the player has such recognition, it is possible to reduce the risk that the player feels discomfort when the non-player character 211 deforms to the suggestion shape as described above.

If at least a part of the non-player character 211 is deleted when the shape of the non-player character 211 is the basic shape, the game system 1 gradually restores the shape of the non-player character 211 to the basic shape according to the lapse of time. Further, if at least a part of the non-player character 211 is deleted when the shape of the non-player character 211 is the suggestion shape, the game system 1 gradually restores the shape of the non-player character 211 to the suggestion shape according to the lapse of time. Thus, regardless of whether the shape of the non-player character 211 is the basic shape or the suggestion shape, the game system 1 can restore the non-player character 211 to the shape immediately before the deletion.

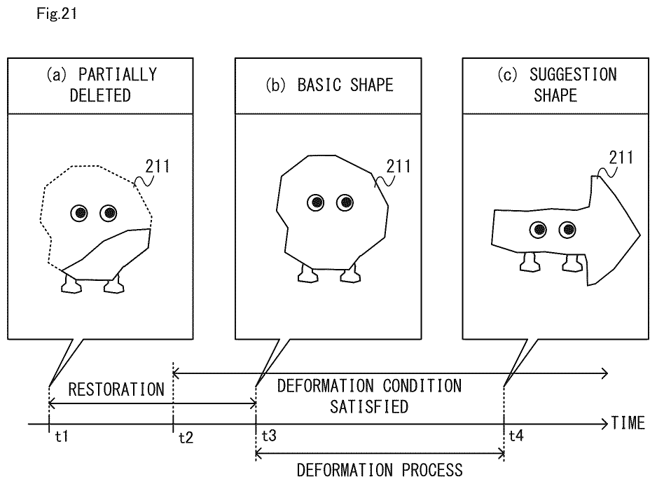

FIG. 21 is a diagram showing an example of change in the non-player character when the deformation condition is satisfied while the partially-deleted non-player character is being restored. In the example shown in FIG. 21, a part of the non-player character 211 is deleted at time t1, the deformation condition regarding the non-player character 211 is satisfied at time t2 when restoration according to the deletion is being performed, and the shape of the non-player character 211 is restored at time t3. In the above case, at time t2 when the deformation condition has been satisfied, the game system 1 does not start the deformation process from the basic shape to the suggestion shape because the non-player character 211 remains partially deleted and is being restored. In the exemplary embodiment, at time t3 when the shape of the partially-deleted non-player character 211 has been restored to the basic shape, if the deformation condition has been satisfied, the game system 1 starts the deformation process from the basic shape to the suggestion shape. Thereafter, the non-player character 211 having the basic shape is deformed to the suggestion shape (time t4).

As described above, in the exemplary embodiment, if the deformation condition is satisfied while the non-player character 211 is being restored to the basic shape, the game system 1 deforms the non-player character 211 to the suggestion shape after the non-player character 211 is restored to the basic shape. Here, if the non-player character 211 is deformed from the shape in the middle of restoration to the suggestion shape without through the basic shape, it is difficult for the user to know the deformation to the suggestion shape, and the non-player character 211 cannot easily attract the attention of the user. Meanwhile, according to the exemplary embodiment, since the non-player character 211 is deformed from the shape in the middle of restoration to the suggestion shape through the basic shape, the non-player character 211 can more reliably attract the attention of the user. Note that in other embodiments, if the deformation condition is satisfied while the non-player character 211 is being restored to the basic shape, the game system 1 may deform the non-player character 211 from the shape in the middle of restoration to the suggestion shape without through the basic shape. At this time, the game system 1 performs interpolation between the shape in the middle of restoration (e.g., the shape at the time when the deformation condition has been satisfied) and the suggestion shape, thereby generating an intermediate shape regarding these two shapes.

If the cancellation condition is satisfied when a part of the non-player character 211 having the suggestion shape has been deleted and thereafter the non-player character 211 is being restored to the suggestion shape, the game system 1 deforms the non-player character 211 to the basic shape after the non-player character 211 is restored to the suggestion shape. Note that the necessity of attracting user' attention is lower in the case where the non-player character 211 is deformed from the suggestion shape to the basic shape than in the case where the non-player character 211 is deformed from the basic shape to the suggestion shape. Therefore, if the deformation condition is satisfied while the partially-deleted non-player character 211 is being restored to the basic shape, the game system 1 deforms the non-player character 211 to the suggestion shape after the non-player character 211 is restored to the basic shape. Meanwhile, if the cancellation condition is satisfied while the partially-deleted non-player character 211 is being restored to the suggestion shape, the game system 1 may deform the non-player character 211 from the shape in the middle of restoration (e.g., the shape at the time when the cancellation condition has been satisfied) to the basic shape without through the suggestion shape.

In the exemplary embodiment, another voxel object can be added to the non-player character 211, like the terrain object described above. Specifically, when a predetermined object (e.g., a rock object having the same material as the body object 221) comes into contact with the body object 221 of the non-player character 211, the game system 1 integrates this object with the body object 221. That is, in the above case, the game system 1 obtains a new shape of the body object 221 by adding the object to the original shape of the body object 221.

If the deformation condition is satisfied in the state where another object is added to the basic shape, the game system 1 deforms the non-player character 211 to the suggestion shape after restoring the non-player character 211 to the basic shape. Thus, in the exemplary embodiment, if the deformation condition is satisfied in the state where the shape of the non-player character is different from the basic shape due to a reason different from deformation from the basic shape to the suggestion shape (e.g., due to addition or deletion performed on the non-player character 211), the game system 1 deforms the non-player character 211 to the suggestion shape after deforming the non-player character 211 to the basic shape. Note that also when the non-player character 211 is deformed from the above state to the suggestion shape without through the basic shape, it is difficult for the user to know the deformation to the suggestion shape, and the non-player character 211 cannot easily attract the attention of the user, as in the case of deforming the non-player character 211 from the partially-deleted shape to the suggestion shape without through the basic shape. Meanwhile, according to the exemplary embodiment, since the non-player character 211 is deformed from the shape to which another object is added, to the suggestion shape through the basic shape, the non-player character 211 can more reliably attract the attention of the user. Note that restoration from the shape to which another object is added, to the basic shape may be performed such that the non-player character 211 gradually deforms over a predetermined time, or may be performed such that the non-player character 211 is restored to the basic shape at one time. In other embodiments, if the deformation condition is satisfied in the above state, the game system 1 may deform the non-player character 211 from the shape to which another object is added, to the suggestion shape without through the basic shape.

If the cancellation condition is satisfied in the state where another object is added to the suggestion shape, the game system 1 deforms the non-player character 211 to the basic shape after restoring the non-player character 211 to the suggestion shape. Note that the restoration from the shape to which another object is added, to the suggestion shape may be performed such that the non-player character 211 gradually deforms over a predetermined time, or may be performed such that the non-player character 211 is restored to the suggestion shape at one time. In other embodiments, if the cancellation condition is satisfied in the above state, the game system 1 may deform the non-player character 211 from the shape to which another object is added, to the basic shape without through the suggestion shape.

Note that also when another object is added to the non-player character 211, the game system 1 may restore the shape of the non-player character 211 to the original shape according to the lapse of time, as in the case where a part of the non-player character 211 is deleted. In this case, when the addition is performed in the state where the non-player character 211 has the basic shape, the non-player character 211 is restored to the basic shape. Meanwhile, when the addition is performed in the state where the non-player character 211 has the suggestion shape, the non-player character 211 is restored to the suggestion shape. Further, if the deformation condition is satisfied in the middle of restoration, the non-player character 211 may be deformed from the shape in the middle of restoration to the suggestion shape through the basic shape. Meanwhile, if the cancellation condition is satisfied in the middle of restoration, the game system 1 may deform the non-player character 211 from the shape in the middle of restoration, to the basic shape through the suggestion shape.

The process of changing the shape of the non-player character 211 has been described above. However, the game system 1 may change the material (specifically, the property and the texture) of the non-player character 211, in addition to the shape of the non-player character 211. That is, the game system 1 may further change at least one of the color, the pattern, and the property of the non-player character, according to the shape of the non-player character being changed from the basic shape to the suggestion shape depending on the deformation condition.

For example, the texture of the non-player character 211 having the basic shape and the texture of the non-player character 211 having the suggestion shape may be set to be different from each other. In this case, the game system 1 may also perform interpolation for the texture to determine the color and the pattern of the intermediate shape.

Further, for example, the property (e.g., hardness) of the non-player character 211 having the basic shape and the property thereof having the suggestion shape may be different from each other. Specifically, the hardness of the non-player character 211 having the basic shape and the hardness thereof having the suggestion shape may be different from each other. Also, a non-player character having the property of not bursting when it has the basic shape may have the property of bursting (due to any impact) when it has the suggestion shape. The game system 1 may also perform interpolation for the property to determine the property of the intermediate shape.

Note that in other embodiments, the game system 1 may not gradually change the material of the non-player character 211 even when the shape of the non-player character 211 is gradually deformed from the basic shape to the suggestion shape by using the intermediate shape. For example, the game system 1 may change the material of the non-player character 211 when the non-player character 211 is deformed to the suggestion shape (or when the non-player character 211 is deformed to a predetermined intermediate shape).

### 3. Specific Example of Processing in Game System

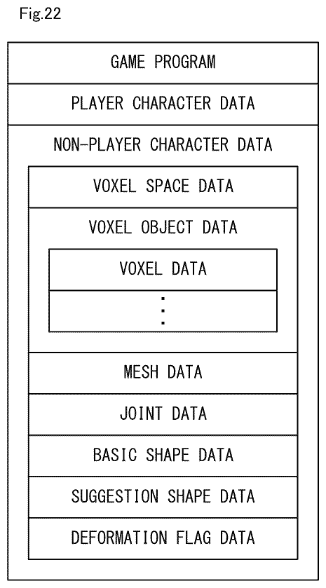

Next, referring to FIG. 22 to FIG. 25, a specific example of information processing in the game system 1 will be described.

FIG. 22 is a diagram showing an example of various data used for the information processing in the game system 1. As shown in FIG. 22, the game system 1 has, stored therein, a game program, player character data, and non-player character data.

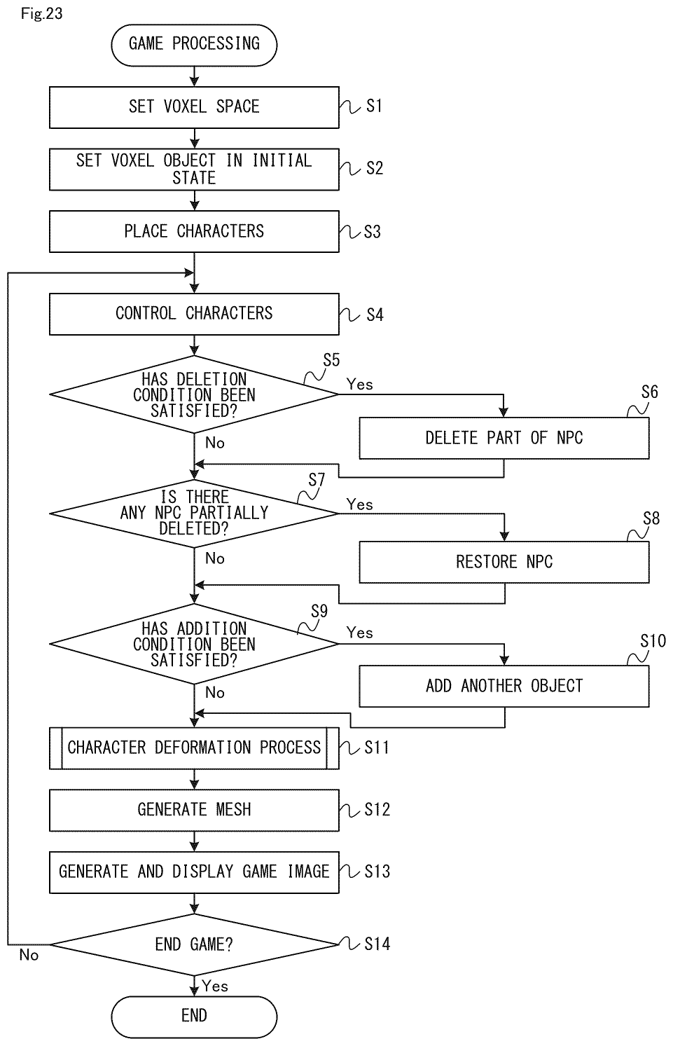

The game program is a game program for executing game processing of the exemplary embodiment (specifically, game processing shown in FIG. 23). The game program is data that is stored in the game system 1 in advance of execution of the game processing. The game program is stored in the storage medium attached to the slot 23 of the main body apparatus 2, for example.

The player character data is data regarding the player character. In the exemplary embodiment, the player character data includes data representing the position of the player character in the game space. The player character data is data generated during execution of the game processing. The player character data is stored in the DRAM 85 in the main body apparatus 2, for example.

The non-player character data is data regarding the non-player character. The non-player character data includes voxel space data, voxel object data, mesh data, basic shape data, suggestion shape data, deformation flag data, and joint data. The non-player character data, except for the basic shape data and the suggestion shape data, is generated during execution of the game processing, and is stored in the DRAM 85 in the main body apparatus 2, for example. The basic shape data and the suggestion shape data are stored in the game system 1 together with the game program (or in the form of being included in the game program) in advance of execution of the game processing. Note that the non-player character data may include data representing the attitude and the state of the non-player character, in addition to the above data.

The voxel space data is data that defines a sub-voxel space regarding the non-player character. Specifically, the voxel space data includes data representing the length of each side of a voxel in the sub-voxel space. Further, the voxel space data includes data representing the position (or the position of the non-player character in the game space), the attitude, and the size of the sub-voxel space in the game space.

The voxel object data includes voxel data regarding the non-player character, that is, voxel data for each voxel in the sub-voxel space. The voxel object data is data that defines the shape of the non-player character in the sub-voxel space.

The mesh data is data that represents a mesh set for the non-player character. The mesh data includes data representing the positions of vertexes in the mesh, for example.

The joint data is data regarding joints set for the non-player character (including joints for determining the positions of the eye object and the foot object). The joint data includes data representing the positions and the connection relationship of the joints.

The basic shape data is data (specifically, voxel data) representing the basic shape of the non-player character. The suggestion shape data is data (specifically, voxel data) representing the suggestion shape of the non-player character. As described above, in the exemplary embodiment, as for the suggestion shape representing an arrow, only suggestion shape data regarding a suggestion shape representing a rightward arrow is prepared, and no suggestion shape data is prepared for suggestion shapes representing arrows in directions other than the rightward direction.

The deformation flag data is data of a deformation flag indicating whether or not the non-player character is in the state to be deformed to the suggestion shape (e.g., whether or not the deformation condition has been satisfied). When the non-player character is in the state to be deformed to the suggestion shape, the deformation flag is set to ON. When the non-player character is not in the state to be deformed to the suggestion shape, the deformation flag is set to OFF. Note that the deformation flag is set to OFF at the start of the game.

Further, the game system 1 has, stored therein, data that defines a main-voxel space set in the game space, data that represents a voxel object (here, the terrain object) placed in the main-voxel space, a mesh that is set for the voxel object (e.g., the mesh for the terrain object), and the like, in addition to the data shown in FIG. 22.

FIG. 23 is a flowchart showing an example of a flow of game processing executed by the game system 1. For example, the game processing shown in FIG. 23 is started when an instruction to start the game has been made by the player during execution of the game program.

In the exemplary embodiment, the processor 81 of the main body apparatus 2 executes the game program stored in the game system 1 to execute processes in steps shown in FIG. 23. However, in other embodiments, a part of the processes in the steps may be executed by a processor (e.g., a dedicated circuit or the like) other than the processor 81. Further, if the game system 1 is communicable with another information processing apparatus (e.g., a server), a part of the processes in the steps shown in FIG. 23 may be executed by the another information processing apparatus. The processes in the steps shown in FIG. 23 are merely examples, and the processing order of the steps may be changed or another process may be executed in addition to (or instead of) the processes in the steps as long as similar results can be obtained.

The processor 81 executes the processes in the steps shown in FIG. 23 by using a memory (e.g., the DRAM 85). That is, the processor 81 stores information (in other words, data) obtained in each process step, into the memory, and reads out the information from the memory when using the information for the subsequent process steps.

In step S1 shown in FIG. 23, the processor 81 sets a voxel space in a game space. Specifically, the processor 81 acquires the voxel space data described above, and stores (in other words, writes) the data into the DRAM 85. In the subsequent game processing, the processor 81 may sometimes refer to the voxel space data when executing a process regarding a voxel object (e.g., the process in step S2). In this case, the processor 81 refers to the voxel space data stored in the DRAM 85. Next to step S1, the process in step S2 is executed.

In step S2, the processor 81 sets, in the game space, a voxel object (specifically, a terrain object) in a main-voxel space. Specifically, the processor 81 acquires voxel data that represents arrangement of the terrain object in the initial state, and stores (in other words, writes) a part or the entirety of the acquired voxel data into the DRAM 85. Note that the voxel data representing the arrangement of the terrain object in the initial state is stored in the storage medium attached to the slot 23 of the main body apparatus 2, for example. Next to step S2, the process in step S3 is executed.

In step S3, the processor 81 places the characters (specifically, the player character and the non-player character) in the game space. Specifically, the processor 81 places each character at a position determined in the game program. At this time, the player character data and the non-player character data including data representing the positions where the respective characters are placed, are stored in the DRAM 85. Next to step S3, the process in step S4 is executed.

In step S4, the processor 81 controls the motions of the characters (specifically, the player character and the non-player character) that appear in the game space. The processor 81 controls the motion of the player character, based on operation data received from the controller 3 or 4, for example. Further, the processor 81 causes the non-player character to perform the motion defined in the game program (e.g., motion of turning its body to the left or right, or swinging up and down while it is standing). Specifically, the processor 81 changes the positions of joints to make the non-player character perform the above motion, and updates the joint data included in the non-player character so as to indicate the positions after the change. Further, the processor 81 updates data that is included in the player character data and represents the position of the player character, and/or data that is included in the non-player character data and represents the position of the non-player character, according to the motions of the respective characters in the game space. Next to step S4, the process in step S5 is executed.

In step S5, the processor 81 determines whether or not a deletion condition for the non-player character has been satisfied as a result of the motions of the respective characters according to the process in step S4. The deletion condition is a condition for deleting a part of the non-player character. In the exemplary embodiment, the deletion condition is that any impact has been imparted to the non-player character (e.g., the player character has punched the non-player character, or another object has been hit against the non-player character). When the determination result in step S5 is positive, the process in step S6 is executed. When the determination result in S5 is negative, the process in step S6 is skipped and the process in step S7 is executed.

In step S6, the processor 81 deletes a part of the non-player character (abbreviated as “NPC” in FIG. 23) for which the deletion condition has been satisfied. Specifically, the processor 81 updates the density indicated by the voxel data regarding the non-player character so as to delete a part of the non-player character. The processor 81 updates the voxel object data stored in the DRAM 85 so as to indicate the density after the change. Next to step S6, the process in step S7 is executed.

In step S7, the processor 81 determines whether or not there is a non-player character, a part of which has been deleted through the process in step S6. When the determination result in step S7 is positive, the process in step S8 is executed. When the determination result in step S7 is negative, the process in step S8 is skipped and the process in step S9 is executed.

In step S8, the processor 81 restores the partially-deleted non-player character to its original shape (e.g., the basic shape or the suggestion shape). Specifically, the processor 81 gradually changes the value of the density data included in the voxel data of the non-player character so as to be restored to the value before the deletion, as described in the above “[2-3. Deformation of non-player character]”. Note that the partially-deleted non-player character need not be restored to the original shape at one time by the process in step S8, and is gradually restored to the original shape through the process in step S8 being repeated a plurality of times. Next to step S8, the process in step S9 is executed.

In step S9, the processor 81 determines whether or not an addition condition for the non-player character has been satisfied as a result of the motions of the respective characters according to the process in step S4. The addition condition is a condition for adding another object to the non-player character. In the exemplary embodiment, the addition condition is that predetermined another object (e.g., a rock object having the same material as the body object) comes into contact with the non-player character. When the determination result in step S9 is positive, the process in step S10 is executed. When the determination result in step S9 is negative, the process in step S10 is skipped and the process in step S11 is executed.

In step S10, the processor 81 adds the another object to the non-player character for which the addition condition has been satisfied. That is, the shape of the non-player character is changed to a shape having the another object added thereto. Specifically, the processor 81 updates the density indicated by the voxel data regarding the non-player character such that the predetermined object is added to the original shape of the non-player character. The processor 81 updates the voxel object data stored in the DRAM 85 so as to indicate the density after the change. Next to step S10, the process in step S11 is executed.

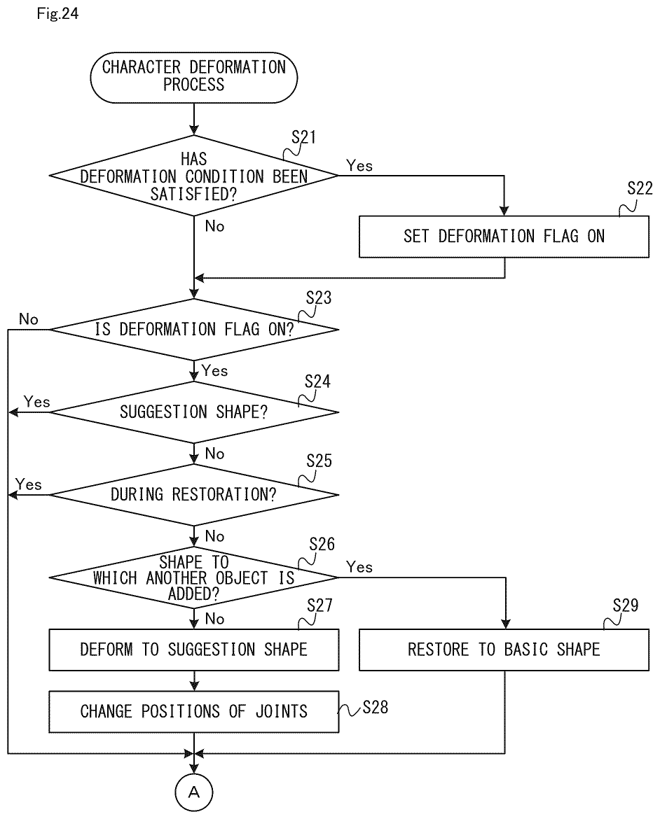

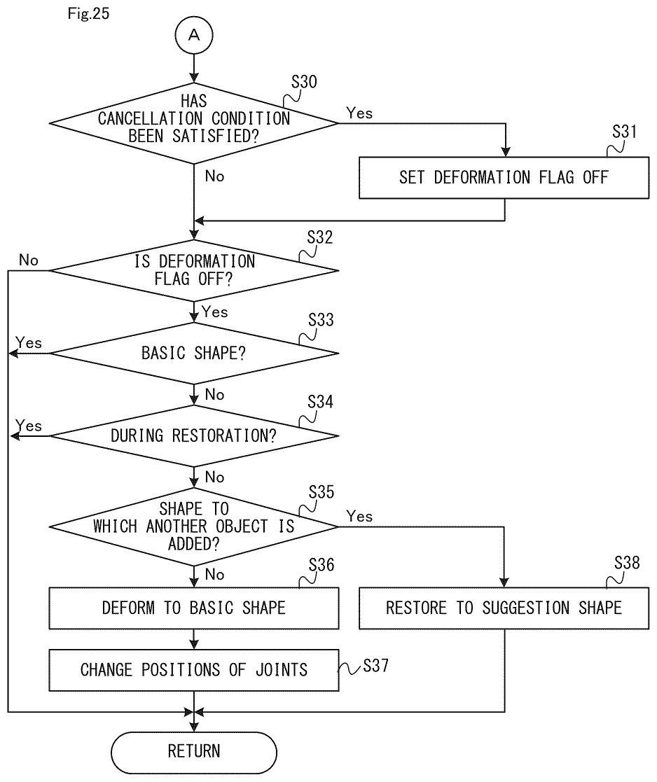

In step S11, the processor 81 executes a character deformation process for deforming the shape of the non-player character. The character deformation process is a process of deforming the non-player character from the basic shape to the suggestion shape, or from the suggestion shape to the basic shape. Hereinafter, a specific flow of the character deformation process will be described with reference to FIG. 24 and FIG. 25.

FIG. 24 and FIG. 25 are sub-flowcharts each showing an example of a specific flow of the character deformation process in step S11 shown in FIG. 23. In the character deformation process, first, in step S21, the processor 81 determines whether or not the deformation condition has been satisfied for any of non-player characters placed in the game space. This determination can be performed based on data that is included in the player character data and represents the position of the player character, and data that is included in the non-player character data and represents the position of the non-player character. When the determination result in step S21 is positive, the process in step S22 is executed. When the determination result in step S21 is negative, the process in step S22 is skipped and the process in step S23 is executed.

In step S22, the processor 81 updates the deformation flag data stored in the DRAM 85 such that the deformation flag of the non-player character that has been determined in step S21 to satisfy the deformation condition, is set to ON. Next to step S22, the process in step S23 is executed.

In step S23, the processor 81 determines whether or not the deformation flag of any of non-player characters placed in the game space is set to ON. When the determination result in step S23 is positive, the process in step S24 is executed. When the determination result in step S23 is negative, the process in step S30 described later is executed (see FIG. 25).

In step S24, the processor 81 determines whether or not the non-player character, the deformation flag of which is ON, has the suggestion shape. The process in step S24 is a process for determining whether or not the non-player character, the deformation flag of which is ON, has already completed deformation to the suggestion shape. When the determination result in step S24 is positive, the process in step S30 described later (see FIG. 25) is executed. When the determination result in step S24 is negative, the process in step S25 is executed.

In step S25, the processor 81 determines whether or not the non-player character, the deformation flag of which is ON, is in the middle of restoration that is performed due to the non-player character having been partially deleted. That is, when the non-player character is being restored according to the process in step S8, this non-player character is determined to be in the middle of restoration; whereas when the non-player character is not being restored, this non-player character is determined not to be in the middle of restoration. When the determination result in step S25 is positive, the processes in steps S26 to S28 are skipped and the process in step S30 described later (see FIG. 25) is executed. That is, when the non-player character is being restored, a deformation process (step S27 described later) for the non-player character to the suggestion shape is not executed. When the determination result in step S25 is negative, the process in step S26 is executed.

In step S26, the processor 81 determines whether or not the non-player character, the deformation flag of which is ON, has a shape to which another object is added. That is, when another object has been added to the non-player character in the process in step S10, this non-player character is determined to have another object being added thereto; whereas when such addition has not been performed, this non-player character is determined not to have another object being added thereto. When the determination result in step S26 is negative, the process in step S27 is executed. When the determination result in step S26 is positive, the process in step S29 is executed.

In step S27, the processor 81 deforms the non-player character, the deformation flag of which is ON, from the basic shape to the suggestion shape. Specifically, the processor 81 gradually changes the value of the density data included in the voxel data of the non-player character, to a value representing the suggestion shape. At this time, the processor 81 may further change at least one of the color, the pattern, and the property of the non-player character by changing the material data included in the voxel data. Note that as described in the above “[2-3. Deformation of non-player character]”, in the exemplary embodiment, the non-player character is not deformed to the suggestion shape at one time by the process in step S27. In the exemplary embodiment, the process in step S27 is repeated a plurality of times while a process loop of steps S4 to S14 is repeatedly executed, whereby the non-player character having the basic shape is deformed to the suggestion shape through an intermediate shape. That is, in the repetition of the process in step S27, the processor 81 generates an intermediate shape through interpolation between the basic shape and the suggestion shape, and gradually deforms the non-player character from the basic shape to the suggestion shape through the intermediate shape. Next to step S27, the process in step S28 is executed.

In step S28, the processor 81 changes the positions of joints of the non-player character, the deformation flag of which is ON. Specifically, as described in the above “[2-3. Deformation of non-player character]”, the processor 81 changes the positions of the joints to the positions corresponding to the shape to which the non-player character is deformed in step S27 (e.g., the intermediate shape or the suggestion shape). At this time, the processor 81 updates the joint data stored in the DRAM 85 so as to indicate the positions after the change. Note that the joints also include the joints corresponding to the eye object. Therefore, in the process in step S28, the position of the eye object is also shifted according to deformation of the body object. In the exemplary embodiment, like the process in step S27, the process in step S28 is also repeated a plurality of times while the process loop of steps S4 to S14 is repeatedly executed, whereby the position of the eye object of the non-player character is gradually shifted. Next to step S28, the process in step S30 (see FIG. 25) is executed.

In step S29, the processor 81 restores the non-player character, the deformation flag of which is ON, from the shape to which another object is added, to the basic shape. Specifically, the processor 81 gradually changes the value of the density data included in the voxel data of the non-player character, to a value representing the basic shape. In the exemplary embodiment, like the process in step S27, the process in step S29 is also repeated a plurality of times while the process loop of steps S4 to S14 is repeatedly executed, whereby the non-player character is gradually deformed from the shape to which another object is added, to the basic shape. Note that after the non-player character has been restored to the basic shape through the process in step S29, (if the deformation flag remains in the ON state,) the non-player character is deformed from the basic shape to the suggestion shape through the process in step S27. Next to step S29, the process in step S30 (see FIG. 25) is executed.

In step S30, the processor 81 determines whether or not the cancellation condition has been satisfied for the non-player character, the deformation flag of which is ON. This determination can be performed based on data that is included in the player character data and represents the position of the player character, and data that is included in the non-player character data and represents the position of the non-player character. When the determination result in step S30 is positive, the process in step S31 is executed. When the determination result in step S30 is negative, the process in step S31 is skipped and the process in step S32 is executed.

In step S31, the processor 81 updates the deformation flag data stored in the DRAM 85 such that the deformation flag of the non-player character, which has been determined in step S30 to satisfy the cancellation condition, is set to OFF. Next to step S31, the process in step S32 is executed.

In step S32, the processor 81 determines whether or not the deformation flag of any of non-player characters placed in the game space is set to OFF. When the determination result in step S32 is positive, the process in step S33 is executed. When the determination result in step S32 is negative, the processor 81 ends the character deformation process.

In step S33, the processor 81 determines whether or not the non-player character, the deformation flag of which is OFF, has the basic shape. The process in step S33 is a process for determining whether or not the non-player character, the deformation flag of which is OFF, has already completed deformation to the basic shape. When the determination result in step S33 is positive, the processor 81 ends the character deformation process. When the determination result in step S33 is negative, the process in step S34 is executed.

In step S34, the processor 81 determines whether or not the non-player character, the deformation flag of which is OFF, is in the middle of restoration that is performed due to the non-player character having been partially deleted. That is, when the non-player character is being restored according to the process in step S8, this non-player character is determined to be in the middle of restoration; whereas when the non-player character is not being restored, this non-player character is determined not to be in the middle of restoration. When the determination result in step S34 is positive, the processes in steps S35 to S38 are skipped, and the processor 81 ends the character deformation process. That is, when the non-player character is being restored, a deformation process (step S36 described later) for the non-player character to the basic shape is not executed. When the determination result in step S34 is negative, the process in step S35 is executed.

In step S35, the processor 81 determines whether or not the non-player character, the deformation flag of which is OFF, has a shape to which another object is added. That is, when another object has been added to the non-player character in the process in step S10, this non-player character is determined to have another object being added thereto; whereas when such addition has not been performed, this non-player character is determined not to have another object being added thereto. When the determination result in step S35 is negative, the process in step S36 is executed. When the determination result in step S35 is positive, the process in step S38 is executed.

In step S36, the processor 81 deforms the non-player character, the deformation flag of which is OFF, from the suggestion shape to the basic shape. Specifically, the processor 81 gradually changes the value of the density data included in the voxel data of the non-player character, to a value representing the basic shape. At this time, the processor 81 may further change at least one of the color, the pattern, and the property of the non-player character by changing the material data included in the voxel data. Note that as described in the above “[2-3. Deformation of non-player character]”, in the exemplary embodiment, the non-player character is not deformed to the suggestion shape at one time by the process in step S36. In the exemplary embodiment, the process in step S36 is repeated a plurality of times while the process loop of steps S4 to S14 is repeatedly executed, whereby the non-player character having the suggestion shape is deformed to the basic shape through an intermediate shape. That is, in the repetition of the process in step S36, the processor 81 generates an intermediate shape through interpolation between the basic shape and the suggestion shape, and gradually deforms the non-player character from the suggestion shape to the basic shape through the intermediate shape. Next to step S36, the process in step S37 is executed.

In step S37, the processor 81 changes the positions of the joints of the non-player character, the deformation flag of which is OFF. Specifically, as described in the above “[2-3. Deformation of non-player character]”, the processor 81 changes the positions of the joints to the positions corresponding to the shape to which the non-player character is deformed in step S27 (e.g., the intermediate shape or the basic shape). At this time, the processor 81 updates the joint data stored in the DRAM 85 so as to indicate the positions after the change. Note that the joints also include the joints corresponding to the eye object. Therefore, in the process in step S37, the position of the eye object is also shifted according to deformation of the body object. In the exemplary embodiment, like the process in step S36, the process in step S37 is also repeated a plurality of times while the process loop of steps S4 to S14 is repeatedly executed, whereby the position of the eye object of the non-player character is gradually shifted. After step S37, the processor 81 ends the character deformation process.

In step S38, the processor 81 restores the non-player character, the deformation flag of which is OFF, from the shape to which another object is added, to the suggestion shape. Specifically, the processor 81 gradually changes the value of the density data included in the voxel data of the non-player character, to a value representing the suggestion shape. In the exemplary embodiment, like the process in step S28, the process in step S38 is also repeated a plurality of times while the process loop of steps S4 to S14 is repeatedly executed, whereby the non-player character is gradually deformed from the shape to which another object is added, to the suggestion shape. Note that after the non-player character has been restored to the suggestion shape through the process in step S38, (if the deformation flag remains in the OFF state,) the non-player character is deformed from the suggestion shape to the basic shape through the process in step S36. After step S38, the processor 81 ends the character deformation process.

Referring back to FIG. 23, the character deformation process in step S11 is followed by the process in step S12. In step S12, the processor 81 generates a mesh for a voxel object. The mesh for the voxel object is generated according to the method described in the above “[2-2. Mesh]”. Note that in step S12, the processor 81 need not again generate a mesh that has been generated in the previous process in step S12, and may again generate a mesh for a character whose voxel data has been changed through the processes in steps S4, S6, S8, S10, and, S11. By the process in step S12, the mesh for the voxel object can be dynamically changed during the game. Note that the processor 81 updates the mesh data stored in the DRAM 85 to the content indicating the newly generated mesh. Next to step S12, the process in step S13 is executed.

In step S13, the processor 81 generates a game image representing a game space, and causes the display device to display the game image. Specifically, the processor 81 generates a game image that represents a game space including the voxel object and the other object. Note that the image of the voxel object is generated according to the method described in the above “[2-2. Mesh]” by using the voxel object data and the mesh data stored in the DRAM 85. The processor 81 causes the display device to display the generated game image. Further, if a conversation is made between the player character and the non-player character (e.g., if the player character is located near the non-player character and an instruction to make a conversation is made by the user), the processor 81 displays a message of the non-player character. Note that during the game, the process in step S13 is repeatedly executed once every predetermined time (e.g., 1 frame time). Next to step S13, the process in step S14 is executed.

In step S14, the processor 81 determines whether or not to end the game. For example, the processor 81 determines whether or not an instruction to end the game has been made by the user. When the determination result in step S14 is negative, the process in step S4 is executed again. Thereafter, a series of processes in steps S4 to S14 is repeated until the processor 81 determines to end the game in step S14. When the determination result in step S14 is positive, the processor 81 ends the game processing shown in FIG. 23.

### 4. Functions and Effects of Exemplary Embodiment, and Modifications

As described above, in the exemplary embodiment, the information processing system (specifically, the game system 1) is configured to include the following means.
Object placement means that places a player object (specifically, the player character 212) and a non-player object (specifically, the non-player character 211) in a virtual space (step S3).
Player movement means that moves the player object in the virtual space, based on a user input (step S4).
Deformation means that deforms the non-player object from a first shape (specifically, the basic shape) to a second shape (specifically, the suggestion shape) that imitates a letter or a mark, according to a first condition (specifically, the deformation condition) including that the player object is located within a first range (specifically, the determination range) in the vicinity of the non-player object, and/or that the player object faces the non-player object (step S27).

According to the above configuration, since the shape of the non-player object itself is deformed, the non-player object can attract more attention of the user. Further, since the second shape after deformation represents a letter or a mark, the second shape can inform any information to the user.

In the exemplary embodiment, the information processing system performs a process of deforming the non-player object from the basic shape to the suggestion shape that is an arrow, and rotating the non-player object to change the direction indicated by the suggestion shape (FIG. 19). In other embodiments, when executing the above process, the information processing system may perform the deformation from the first shape to the second shape not according to the first condition but according to any condition. The information processing system may perform deformation in the above process, according to a condition regarding the game state (e.g., the game story being progressed, or the weather having been changed during the game) and/or a condition regarding the non-player object (e.g., the non-player object being in a predetermined state, such as having reduced hit points), for example. For example, the non-player object may be deformed to a shape imitating an umbrella according to the weather in the game being rainy.

In other embodiments, the second shape may not necessarily be a shape representing a letter or a mark, and may be a shape other than letters and marks. For example, the information processing system may deform the non-player object into a flat surface shape, and change the property of the non-player object so as to have elasticity. In this case, the information processing system may cause the player object to jump high by using the deformed non-player object having elasticity as a springboard.

In the exemplary embodiment, when a process is executed by using data (including a program) in a certain information processing apparatus, a part of the data required for the process may be transmitted from another information processing apparatus different from the certain information processing apparatus. In this case, the certain information processing apparatus may execute the process by using the data received from the another information processing apparatus and the data stored therein.

In other embodiments, the information processing system may not include some of the components in the above embodiment, and may not execute some of the processes executed in the above embodiment. For example, in order to achieve a specific effect of a part of the above embodiment, the information processing system includes a configuration for achieving the effect and executes a process for achieving the effect, and need not include other configurations and need not execute other processes.

The exemplary embodiment can be used as, for example, a game system and a game program for the purpose of drawing more attention of the user to a non-player object, for example.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable storage medium having stored therein instructions that, when executed, cause one or more processors of an information processing apparatus to execute information processing comprising:
placing a player object and a non-player object in a virtual space;
moving the player object in the virtual space, based on a user input; and
deforming the non-player object from a first shape to a second shape that imitates a letter or a mark, according to a first condition including that the player object is located within a first range in the vicinity of the non-player object, and/or that the player object faces the non-player object.

2. The non-transitory computer-readable storage medium according to claim 1, wherein
the second shape is a letter or a mark representing a direction.

3. The non-transitory computer-readable storage medium according to claim 2, wherein
the non-player object is deformed from the first shape to the second shape that is an arrow, and the direction represented by the second shape is changed by rotating the non-player object.

4. The non-transitory computer-readable storage medium according to claim 1, wherein
the second shape imitates “!” or “?”.

5. The non-transitory computer-readable storage medium according to claim 1, wherein the information processing further comprises:
causing a display device to display a message from the non-player object, according to a display condition having been satisfied.

6. The non-transitory computer-readable storage medium according to claim 5, wherein
the message indicates a content regarding the second shape.

7. The non-transitory computer-readable storage medium according to claim 6, wherein
the second shape imitates an arrow, and
the message is a sentence that gives a direction to the player object.

8. The non-transitory computer-readable storage medium according to claim 6, wherein
the second shape imitates “?”, and
the message is a question to the player object.

9. The non-transitory computer-readable storage medium according to claim 1, wherein
the non-player object is gradually deformed from the first shape to the second shape.

10. The non-transitory computer-readable storage medium according to claim 9, wherein
the shape of the non-player object is determined based on voxel data of each voxel that is set in a voxel space, and
the non-player object is gradually deformed from the first shape to the second shape through an interpolation process using the voxel data representing the first shape and the voxel data representing the second shape.

11. The non-transitory computer-readable storage medium according to claim 9, wherein the information processing further comprises:
in a case where at least a part of the non-player object is deleted when the non-player object has the first shape, gradually restoring the shape of the non-player object to the first shape according to a lapse of time; and
in a case where at least a part of the non-player object is deleted when the non-player object has the second shape, gradually restoring the shape of the non-player object to the second shape according to a lapse of time.

12. The non-transitory computer-readable storage medium according to claim 11, wherein
in a case where the first condition is satisfied when the non-player object is in the middle of restoration to the first shape, the non-player object is restored to the first shape and thereafter is deformed to the second shape.

13. The non-transitory computer-readable storage medium according to claim 1, wherein
in a case where the first condition is satisfied when the shape of the non-player object is different from the first shape due to a reason different from deformation from the first shape to the second shape, the non-player object is deformed to the first shape and thereafter is deformed to the second shape.

14. The non-transitory computer-readable storage medium according to claim 1, wherein
the non-player object has a first part that deforms from the first shape to the second shape, and a second part different from the first part, and
the position of the second part is changed according to deformation of the first part from the first shape to the second shape.

15. The non-transitory computer-readable storage medium according to claim 14, wherein
the position of the second part is gradually changed according to gradual deformation of the first part from the first shape to the second shape.

16. The non-transitory computer-readable storage medium according to claim 14, wherein
the non-player object is a non-player character, and
the second part is eyes of the non-player character.

17. The non-transitory computer-readable storage medium according to claim 1, wherein the information processing further comprises:
causing the non-player object to perform the same motion, when the non-player object has the first shape and when the non-player object has the second shape.

18. The non-transitory computer-readable storage medium according to claim 1, wherein the information processing further comprises:
deforming the non-player object from the second shape to the first shape according to a second condition that is not satisfied when the first condition is satisfied, the second condition including that the player object is located outside a second range that is a range in the vicinity of the non-player object and is the same as or different from the first range, and/or that the player object does not face the non-player object.

19. The non-transitory computer-readable storage medium according to claim 1, wherein
when the player object is located within a reference distance from the non-player object, the non-player object is deformed from the first shape to the second shape.

20. The non-transitory computer-readable storage medium according to claim 1, wherein
at least one of the color, pattern, and property of the non-player object is further changed according to change of the shape of the non-player object from the first shape to the second shape due to the first condition.

21. An information processing system, comprising one or more processors that are configured to execute information processing comprising:
placing a player object and a non-player object in a virtual space;
moving the player object in the virtual space, based on a user input; and
deforming the non-player object from a first shape to a second shape that imitates a letter or a mark, according to a first condition including that the player object is located within a first range in the vicinity of the non-player object, and/or that the player object faces the non-player object.

22. An information processing apparatus, comprising g one or more processors that are configured to execute information processing comprising:
placing a player object and a non-player object in a virtual space;
moving the player object in the virtual space, based on a user input; and
deforming the non-player object from a first shape to a second shape that imitates a letter or a mark, according to a first condition including that the player object is located within a first range in the vicinity of the non-player object, and/or that the player object faces the non-player object.

23. An information processing method performed on an information processing system, the information processing method comprising: placing a player object and a non-player object in a virtual space;
moving the player object in the virtual space, based on a user input; and
deforming the non-player object from a first shape to a second shape that imitates a letter or a mark, according to a first condition including that the player object is located within a first range in the vicinity of the non-player object, and/or that the player object faces the non-player object.
